(19) United States
(12) Patent Application Publication
(10) Pub. No.: US 2024/0317304 A1
(43) Pub. Date: Sep. 26, 2024

(54) INFORMATION PROCESSING DEVICE AND INFORMATION PROCESSING SYSTEM

(71) Applicant: SONY SEMICONDUCTOR SOLUTIONS CORPORATION, KANAGAWA (JP)

(72) Inventor: EIJI OBA, KANAGAWA (JP)

(21) Appl. No.: 18/578,912

(22) PCT Filed: Mar. 24, 2022
(86) PCT No.: PCT/JP2022/014147

§ 371 Date: Jan. 12, 2024

(30) Foreign Application Priority Data
Jul. 30, 2021 (JP) 2021-126098

(51) Int. Cl. B62D 6/00; B60W 30/02; B60W 50/10; B60W 50/14; B60W 60/00

(52) U.S. Cl. CPC B62D 6/001; B60W 30/02; B60W 50/10; B60W 50/14; B60W 60/001; B60W 60/005; B60W 2540/21; B60W 2540/26

(57) ABSTRACT

Provided is an information processing device (200) for performing automatic steering of a traveling body, the information processing device including: an option presentation unit (218) that presents a plurality of options of steering content in a second section when the traveling body moves from a first section in which automatic steering based on determination by the information processing device is allowed to the second section in which automatic steering based on determination by the information processing device is not allowed; an input unit (220) that receives, from a passenger of the traveling body, input of the option selected by the passenger's own determination; and a control unit (224) that performs steering control of the traveling body on the basis of the option that has been received.

### FIELD

The present disclosure relates to an information processing device and an information processing system.

### BACKGROUND

In recent years, technology related to autonomous driving has been actively developed. The autonomous driving technology is technology for autonomously traveling on a road using a control system mounted on a vehicle (traveling body) and is predicted to rapidly spread in the future.

### CITATION LIST

### Patent Literature

Patent Literature 1: JP 2019-23062 A

### SUMMARY

### Technical Problem

The autonomous driving technology proposed to date is designed on the premise of use by an able-bodied person, and the use by a disabled person has not been sufficiently studied.

Therefore, the present disclosure proposes an information processing device and an information processing system related to autonomous driving technology that enables use also by a disabled person.

### Solution to Problem

According to the present disclosure, there is provided an information processing device for performing automatic steering of a traveling body. The information processing device includes: an option presentation unit that presents a plurality of options of steering content in a second section, when the traveling body moves from a first section in which automatic steering based on determination by the information processing device is allowed to the second section in which automatic steering based on determination by the information processing device is not allowed; an input unit that receives, from a passenger of the traveling body, input of the option selected by the passenger's own determination; and a control unit that performs steering control of the traveling body on a basis of the option that has been received.

Furthermore, according to the present disclosure, there is provided an information processing system for performing automatic steering of a traveling body. The information processing system includes: an option presentation unit that presents a plurality of options of steering content in a second section, when the traveling body moves from a first section in which automatic steering based on determination by the information processing system is allowed to the second section in which automatic steering based on determination by the information processing system is not allowed; an input unit that receives, from a passenger of the traveling body, input of the option selected by the passenger's own determination; and a control unit that performs steering control of the traveling body on a basis of the option that has been received.

### BRIEF DESCRIPTION OF DRAWINGS

FIG. 1 is an explanatory table for explaining an example of driving automation levels.

FIG. 2 is a flowchart for explaining an example of traveling according to an embodiment of the present disclosure.

FIG. 3 is an explanatory diagram for explaining an example of transition between driving automation levels according to the embodiment of the present disclosure.

FIG. 4 is a block diagram illustrating a configuration example of a vehicle control system 11 as an example of a mobile device control system to which the technology of the present disclosure is applied.

FIG. 5 is a diagram illustrating an example of sensing areas.

FIG. 6 is an explanatory diagram for explaining use situations of autonomous driving.

FIG. 7 is an explanatory diagram for explaining cognition, determination, and operation in autonomous driving.

FIG. 8 is an explanatory diagram for explaining an exemplary case of user intervention in the embodiment of the present disclosure.

FIG. 9 is a block diagram illustrating a configuration example of a main part of the vehicle control system 11 according to the embodiment of the present disclosure.

FIG. 10 is a flowchart (part 1) illustrating an example of a processing method according to an embodiment of the present disclosure.

FIG. 11A is a flowchart (part 2) illustrating an example of a processing method according to an embodiment of the present disclosure.

FIG. 11B is a flowchart (part 3) illustrating an example of a processing method according to an embodiment of the present disclosure.

FIG. 12 is an explanatory diagram for explaining an example of display by an HMI according to a comparative example.

FIG. 13 is an explanatory diagram (part 1) for explaining an example of display by the HMI according to the embodiment of the present disclosure.

FIG. 14 is an explanatory diagram (part 2) for explaining an example of display by the HMI according to the embodiment of the present disclosure.

FIG. 15 is an explanatory diagram (part 3) for explaining an example of display by the HMI according to the embodiment of the present disclosure.

FIG. 16 is an explanatory diagram for explaining an example of input by the HMI according to the embodiment of the present disclosure.

FIG. 17 is a hardware configuration diagram illustrating an example of a computer 1000 that implements at least some functions of a block 200.

### DESCRIPTION OF EMBODIMENTS

Hereinafter, preferred embodiments of the present disclosure will be described in detail by referring to the accompanying drawings. Note that, in the present specification and the drawings, components having substantially the same functional configuration are denoted by the same symbols, and redundant description is omitted. Meanwhile, in the present specification and the drawings, a plurality of components having substantially the same or similar functional configurations may be distinguished by attaching different alphabets after the same symbol. However, in a case where it is not particularly necessary to distinguish each of the plurality of components having substantially the same or similar functional configurations, only the same symbol is attached.

Note that the description will be given in the following order.
1. Example of Driving Automation Levels
2. Example of Traveling
3. Example of Transition Between Driving Automation Levels
4. Configuration Example of Vehicle Control System
5. Background of Creation of Embodiments of Present Disclosure
6. Embodiments
6.1 Use Situations
6.2 Cognition, Determination, and Operation
6.3 Exemplary Case of User Intervention
6.4 Functional Configuration
6.5 Processing Method
6.6 Provision of Incentives
6.7 Instruction Input
6.8 HMI Focused on Display
6.9 HMI Focused on Voice Recognition
6.10 Use Cases
7. Summary
8. Hardware Configuration
9. Supplements

### 1. EXAMPLE OF DRIVING AUTOMATION LEVELS

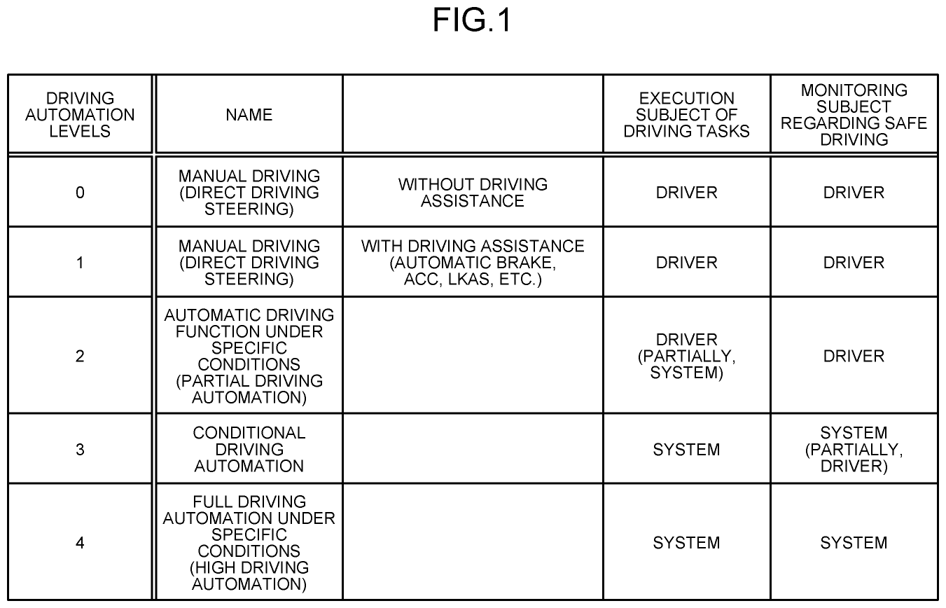

First, before describing details of an embodiment of the present disclosure, driving automation levels of the autonomous driving technology will be described with reference to FIG. 1. FIG. 1 is an explanatory table for explaining an example of driving automation levels. Illustrated in FIG. 1 are driving automation levels defined by the society of automotive engineers (SAE). Note that, in the following description, the driving automation levels defined by the SAE will be basically referred to. However, in the study of the driving automation levels illustrated in FIG. 1, problems or appropriateness in a case where the autonomous driving technology is widely spread are not thoroughly studied. Therefore, in the following description, there are some parts not necessarily described in accordance with the interpretation as defined by the SAE in consideration of these problems and the like.

In the present specification, vehicle traveling is not roughly divided into two types of manual driving and autonomous driving as described above but classified in stages depending on the content of tasks autonomously performed by the system side. For example, as illustrated in FIG. 1, it is based on the premise that the driving automation levels are classified into, for example, five levels from level 0 to level 4 (note that, in a case of including up to a level at which unmanned autonomous driving is possible, there are six levels). First, the driving automation level 0 is manual driving without driving assistance by a vehicle control system (direct driving steering by a driver), and the driver executes all driving tasks and also executes monitoring regarding safe driving (for example, an action of avoiding danger).

Next, the driving automation level 1 is manual driving (direct driving steering) in which driving assistance (autonomous brake, adaptive cruise control (ACC), lane keeping assistant system (LKAS), and the like) by the vehicle control system can be executed, and the driver executes all driving tasks other than an assisted single function and also executes monitoring regarding safe driving.

Next, the driving automation level 2 is also referred to as “partial driving automation”, in which the vehicle control system executes sub-tasks of the driving task related to vehicle control in both the front-rear direction and the left-right direction of the vehicle under a specific condition. For example, at the driving automation level 2, the vehicle control system controls both the steering operation and acceleration and deceleration in mutual cooperation (for example, cooperation between ACC and LKAS). However, even at the driving automation level 2, the execution subject of the driving task is basically the driver, and the monitoring subject related to safe driving is also the driver.

Furthermore, the driving automation level 3 is also referred to as “conditional driving automation”, in which all the driving tasks can be executed in a limited area in which conditions are satisfied that enable the vehicle control system to handle by functions mounted on the vehicle. In the driving automation level 3, the execution subject of the driving tasks is the vehicle control system, and the monitoring subject related to safe driving is also basically the vehicle control system. However, at this level, the vehicle control system is not required to handle all situations. The user (driver) at the time of backup handling is expected to appropriately respond to an intervention request or the like of the vehicle control system, and in some cases, it is required to handle a system failure that is a so-called silent failure that the vehicle control system cannot autonomously find.

Meanwhile, in the driving automation level 3 defined by the SAE, what type of secondary tasks (here, the “secondary tasks” refer to operations other than the operations related to driving that are performed by the driver during traveling) the driver can actually execute is not clearly defined.

Specifically, it is conceivable that the driver can perform operations or actions other than steering, for example, secondary tasks such as operation of a mobile terminal, a telephone conference, video viewing, reading, a game, thinking, or conversation with other passengers during traveling at the driving automation level 3. On the other hand, in the range of the definition of the driving automation level 3 by the SAE, it is expected that the driver appropriately handles such as performing a driving operation in response to a request or the like from the vehicle control system side due to a system failure, deterioration of a traveling environment, or the like. Therefore, at the driving automation level 3, even in a situation where a secondary task as described above is executed in order to ensure safe traveling, the driver is expected to be constantly maintained in a prepared state in which the driver can immediately return to manual driving.

Furthermore, the driving automation level 4 is also referred to as “high driving automation”, in which the vehicle control system performs all driving tasks within a limited area. In the driving automation level 4, the execution subject of the driving tasks is the vehicle control system, and the monitoring subject related to safe driving is also the vehicle control system. However, unlike the driving automation level 3, at the driving automation level 4, it is not expected that the driver handles such as performing a driving operation (manual driving) in response to a request or the like from the vehicle control system side due to a system failure or the like. Therefore, at the driving automation level 4, the driver can perform a secondary task as described above, and depending on the situation, for example, the driver can take a temporary nap in a section where conditions are met.

As described above, in the driving automation level 0 to the driving automation level 2, the vehicle travels in a manual driving mode in which all or some of the driving tasks are executed by the driver independently. Therefore, at these three driving automation levels, it is not allowed for the driver to be engaged in a secondary task that is an action other than manual driving and actions related thereto, such as that reduces attention or impairs attention to the front during traveling.

On the other hand, at the driving automation level 3, the vehicle travels in an autonomous driving mode in which the vehicle control system independently executes all the driving tasks. However, as described above, there may be a situation in which the driver performs a driving operation at the driving automation level 3. Therefore, at the driving automation level 3, in a case where the secondary tasks are allowed to the driver, the driver is required to be in a prepared state in which the driver can return from the secondary task to manual driving.

Furthermore, in a case where the situation that allows the vehicle to travel at the driving automation level 4 is deemed to be satisfied, the vehicle travels in the autonomous driving mode in which the vehicle control system executes all the driving tasks. However, since the situation dynamically changes depending on a maintenance situation of the actual road infrastructure, a change in weather, a change in the performance of the vehicle itself due to an incoming flying stone, a flying object, or the like, a section in which the driving automation level 4 cannot be applied may be found in a part of a travel route in the middle of the travel plan. In such a case, before approaching and entering the section, it is required to set and transition to, for example, the driving automation level 2 or less that can be enabled depending on conditions. Then, in the section set to the driving automation level 2 or less in this manner, the driver is required to execute the driving task independently. That is, even in the case of the driving automation level 4, since the situation changes from moment to moment in the middle of the travel plan as described above, even in the middle of the travel plan planned in advance as at the driving automation level 4, the transition to the driving automation level 2 or less may actually occur. Therefore, the driver is required to shift to the prepared state in which the driver can return from the secondary task to manual driving at appropriate advance notice timing after the transition between driving automation levels is notified.

What is important herein is that the driving automation levels in which the vehicle can be controlled, namely, the driving automation levels 0 to 4, are levels in which the control corresponding one of the driving automation classifications change depending on a situation where the control is possible, and that in general use, even in a vehicle having autonomous traveling performance up to the driving automation level 4, traveling at this driving automation level is not constantly ensured for the vehicle.

### 2. EXAMPLE OF TRAVELING

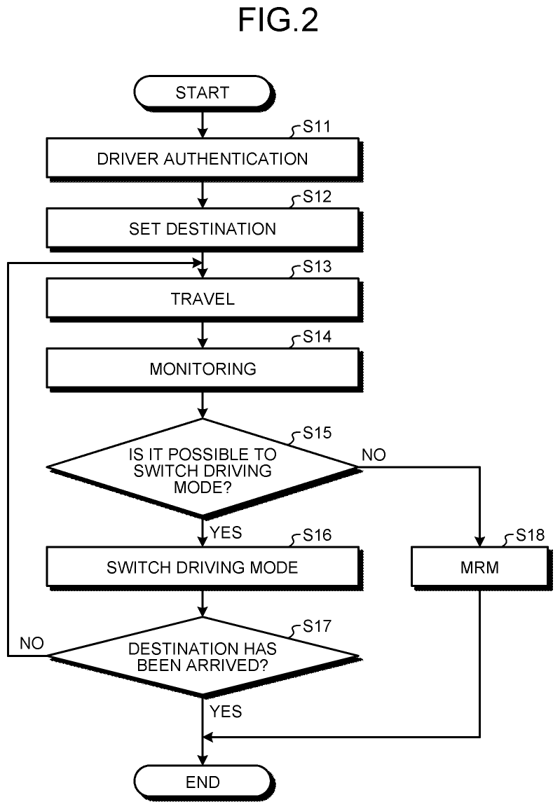

Next, an example of traveling according to an embodiment of the present disclosure will be described with reference to FIG. 2 on the basis of the driving automation levels described above. FIG. 2 is a flowchart for explaining an example of traveling according to the embodiment of the present disclosure. As illustrated in FIG. 2, in traveling according to the embodiment of the present disclosure, a vehicle control system executes, for example, steps from Step S11 to Step S18. Details of each of these steps will be described below.

First, the vehicle control system executes driver authentication (Step S11). The driver authentication can be performed by belongings authentication using a driver's license, a vehicle key (including a portable wireless device), or the like, knowledge authentication using a password, a personal identification number, or the like, or biometric authentication using the face, a fingerprint, an iris of a pupil, a voiceprint, or the like. Furthermore, in the present embodiment, the driver authentication may be performed by using all or two or more of the belongings authentication, the knowledge authentication, and the biometric authentication. In the present embodiment, by executing such driver authentication before starting traveling, even in a case where a plurality of drivers drives the same vehicle, it is possible to acquire information unique to each of the drivers such as a history of behavior, characteristics, and the like of the driver in association with the driver. Note that, in the present embodiment, in a case where a plurality of passengers (occupants) board the vehicle and a plurality of passengers can be drivers, it is preferable to perform authentication for all the drivers.

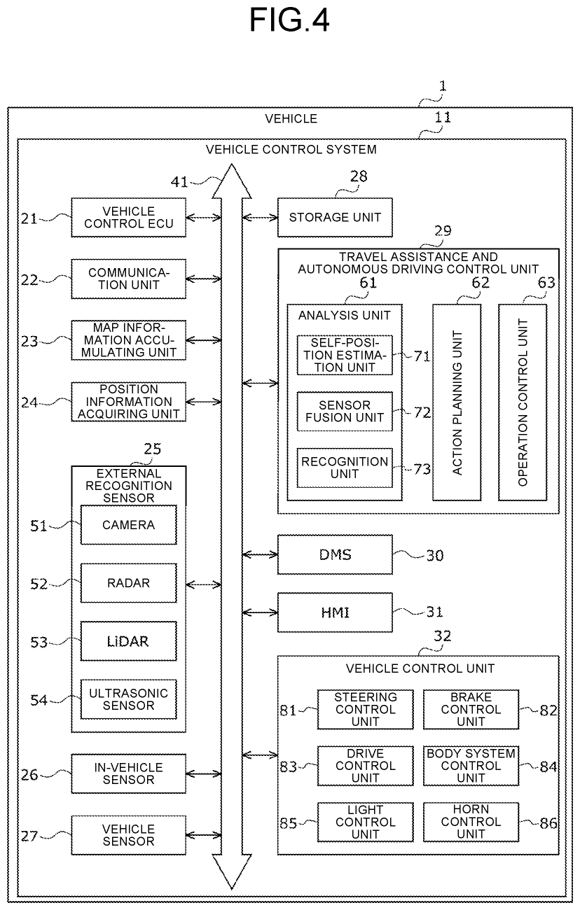

Next, a destination is set by the driver or others operating, for example, a human-machine interface (HMI) 31 (see FIG. 4) to be described later (Step S12). Note that the example in which a passenger boards the vehicle and sets the destination has been described here; however, the embodiment of the present disclosure is not limited thereto. For example, the vehicle control system may set a destination in advance on the basis of destination information or calendar information manually input to a smartphone or the like (those capable of communicating with the vehicle control system) before boarding the vehicle. Alternatively, the vehicle control system may automatically set the destination in advance by acquiring schedule information or the like stored in advance in a smartphone or the like, a cloud server or the like (assumed to be communicable with the vehicle control system) via concierge service.

Then, the vehicle control system performs preplanning setting of a traveling route or the like on the basis of the set destination. The vehicle control system further acquires and updates information of the road environment of the set travel route and the like, namely, local dynamic map (LDM) information and the like in which travel map information of the road on which the vehicle travels is constantly updated at high density. At this point, the vehicle control system repeats the acquisition of the LDM and the like corresponding to a section to be traveled subsequently for every certain section along the travel during the travel plan. In addition, the vehicle control system updates and resets an appropriate driving automation level as appropriate for each section on the travel route on the basis of the acquired latest LDM information and the like. Therefore, even in a case where entry into a section is started as the driving automation level 4, in a case where a new succession point to manual driving, which has not been found at the time of the start of the travel plan, is detected from the information updated every moment, the driver is required to recognize a notification requesting takeover or to take over depending on a changed part.

Next, the vehicle control system starts displaying the travel sections on the travel route. Then, the vehicle control system starts traveling in accordance with the set driving automation level (Step S13). Note that, after the traveling is started, the display of the travel sections is updated on the basis of the position information of the vehicle (host vehicle) and the acquired LDM update information. Note that, in the present specification, “traveling” also includes a safety measure that is autonomously performed when the driver cannot return from autonomous driving to manual driving, and more specifically, for example, stopping the vehicle accompanying a minimal risk maneuver (MRM) or the like determined by the vehicle control system is also included.

Next, the vehicle control system executes monitoring (observation) of the state of the driver as appropriate (Step S14). In the embodiment of the present disclosure, the monitoring is executed, for example, to acquire training data for determining a return handling level of the driver. Furthermore, in the present embodiment, the monitoring is executed in a situation where it is necessary to confirm depending on temporal changes in the travel environment such as the state confirmation of the driver in advance necessary for switching the driving mode in accordance with a driving automation level set in each section on the travel route, whether or not a return notification is performed at appropriate timing on the basis of estimation information of the initial state of driving that is observed from periodic monitoring, and whether or not the driver has appropriately performed the return action in response to the notification or a warning, including an unexpected request to return to manual driving from the autonomous driving generated after the start of the travel plan. In a case where a disabled person, as a driver, uses a vehicle equipped with an autonomous driving function as a means of travel, options of handling in a subsequent course are limited when the traveling proceeds. Therefore, before passing a limit point at which it is possible to secure time to examine a countermeasure before such a situation occurs, it is desirable that the disabled person know prediction information about the traveling course, grasp the situation, and make the best choice. Therefore, it is desirable that the monitoring (observation) of the state of the driver (disabled person) is performed to such an extent that it can be determined that the arousal and posture situations allow situation recognition even when the most recent situation does not require the driver to return to intervention of control.

Next, when the vehicle reaches the switching point from the autonomous driving mode to the manual driving mode based on the driving automation level set for each section on the travel route, the vehicle control system determines whether or not the driving mode can be switched (Step S15). Then, if the vehicle control system determines that the driving mode can be switched (Step S15: Yes), the process proceeds to processing of Step S16. If it is determined that the driving mode cannot be switched (Step S15: No), the process proceeds to processing of Step S18, for example.

Next, the vehicle control system switches the driving mode (Step S16). The vehicle control system further determines whether or not the vehicle (host vehicle) has arrived at the destination (Step S17). The vehicle control system ends the processing if the vehicle has arrived at the destination (Step S17: Yes) or returns to the processing of Step S13 if the host vehicle has not arrived at the destination (Step S17: No). Thereafter, the vehicle control system repeats the processing from Step S13 to Step S17 as appropriate until the vehicle arrives at the destination. Moreover, in a case where the driving mode cannot be switched from the autonomous driving to manual driving, the vehicle control system may execute an emergency stop using the MRM or the like (Step S18).

Note that the flowchart of FIG. 2 is a diagram for schematic description, and the flow is illustrated as a simple model by omitting explanations or description of detailed steps regarding detailed procedures accompanying takeover, a state check at the time of the takeover, or a detailed procedure of handling processing or determination by automatic control. That is, the processing in Step S13 includes a series of handling processing that is automatically performed when the driver cannot return, and description thereof is omitted.

Note that, in the embodiment of the present disclosure, even in the same road section, an allowable driving automation level can change from moment to moment depending on the vehicle performance, road situations, the weather, and others. In addition, even in the same vehicle, an allowable operational design domain (ODD) may also change depending on a case where detection performance is deteriorated due to primary contamination of devices mounted on the own vehicle, contamination of sensors, or the like. Therefore, an allowable driving automation level may also change during traveling from the departure place to the destination. Furthermore, in a case of a transition between driving automation levels that requires switching handling from the autonomous driving to manual driving, a takeover section for the handling may also be set. Therefore, in the embodiment of the present disclosure, the ODD is set and updated on the basis of various types of information that change from moment to moment. Note that, in the present specification, an actual use range for each driving automation level allowed depending on the infrastructure, the travel environment, and the like is referred to as an “operation design domain” (ODD).

Furthermore, in a case where the ODD set for the traveling vehicle changes, the content of the secondary tasks allowed to the driver also changes. In other words, since the content of unacceptable secondary tasks changes depending on the ODD, the range of the content of actions regarded as the driver's violation of the traffic rules also changes. For example, although it is allowed to perform a secondary task such as reading in the case of the driving automation level 4, in the case of transition to the driving automation level 2, a secondary task such as reading constitutes a violation of the rules. In addition, since there is also a sudden transition between driving automation levels in the autonomous driving, the driver is required to be in a prepared state in which the driver can immediately return to manual driving from the secondary task depending on the situation.

### 3. EXAMPLE OF TRANSITION BETWEEN DRIVING AUTOMATION LEVELS

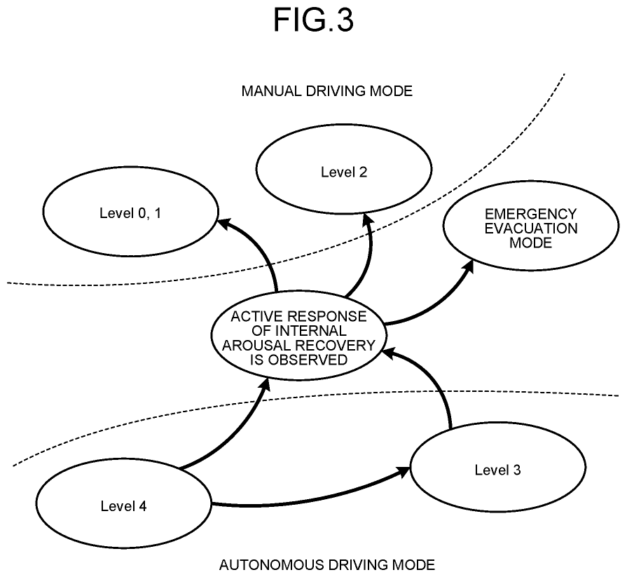

Next, an example of transition between driving automation levels according to the embodiment of the present disclosure will be described in more detail with reference to FIG. 3. FIG. 3 is an explanatory diagram for explaining an example of transition between driving automation levels according to the embodiment of the present disclosure.

As illustrated in FIG. 3, it is based on the premise that switching from the autonomous driving mode (the lower area in FIG. 3) to the manual driving mode (the upper area in FIG. 3) is executed, for example, upon transition from a section of the driving automation level 3 and the driving automation level 4 on the travel route to a section of the driving automation levels 0 and 1 and the driving automation level 2.

Meanwhile, it is difficult for the driver to consciously maintain the prepared state in which the driver can return to manual driving while traveling in the autonomous driving mode. For example, while traveling in the autonomous driving mode, it is conceivable that the driver is focused on a secondary task such as sleeping (nap), viewing of television or a video, or a game. Alternatively, for example, the driver may gaze at the front or the surroundings of the automobile as in the manual driving only that the hands are not on the steering wheel, may be reading a book, or may be dozing. Moreover, the arousal level (consciousness level) of the driver varies due to a difference in these secondary tasks.

Furthermore, if the driver falls asleep during traveling in the autonomous driving mode, the driver's consciousness level or determination level enters a lowered state, that is, a state in which the arousal level is lowered. Since the driver cannot perform normal manual driving in the state in which the arousal level is lowered, there is a possibility of causing an accident in the worst case when it is switched to the manual driving mode in that state. Therefore, even in the state in which the arousal level is lowered, the driver is required to return to a high arousal state in which the driver can drive the vehicle under normal consciousness (internal arousal recovered state) immediately before switching to the manual driving mode. That is, in order to ensure safe traveling, switching from the autonomous driving mode to the manual driving mode is required to be executed only when it can be observed that the internal arousal state of the driver is recovered.

Therefore, in the embodiment of the present disclosure, in order to avoid induction of an accident or the like, such switching of the driving modes can be executed only in a case where the driver is at the return handling level to the manual driving mode, namely, a case where an active response indicating the internal arousal recovery (a state in which the internal arousal state of the driver has been recovered) can be observed (illustrated in the center of FIG. 3). In addition, in the present embodiment, as illustrated in FIG. 3, in a case where no active response indicating internal arousal recovery can be observed, it is switched to an emergency evacuation mode such as the MRM. Incidentally, in the emergency evacuation mode, processing such as deceleration, stop, or parking on a road, a side strip, or an evacuation space is performed. In addition, in FIG. 3, regarding transition from the driving automation level 4 to the driving automation level 3, since the driver does not necessarily approach the point where it is necessary to immediately take an action as an operation action to switch the driving mode, it is not possible to expect at all to observe an active response indicating the internal arousal recovery as described above. However, the present embodiment is not limited to the example as illustrated in FIG. 3, and even in the transition from the driving automation level 4 to the driving automation level 3, the transition may be performed as long as conditions are satisfied that a safety measure and emergency evacuation which can be remotely assisted can be performed without adversely affecting following vehicles on the basis of the observation or the observation result as described above even if the driver cannot perform the driving steering or the driver cannot handle. Note that, even when there is an active response of the driver, the response may be a reactive action without a normal aroused thought, and the driver is not always in a state of accurately grasping all related situations. Therefore, ensuring safety can be said to be a required condition for takeover of steering.

Specifically, in a case where no active response indicating the internal arousal recovery is observed when the transition from the driving automation level 4 to the driving automation level 3 is performed, even though the driver shall be obliged to return to manual driving by the legal system, the driver may not always be in a state in which it is possible to appropriately respond to a request to intervene (RTI) as the driving automation level 3 from the vehicle control system. More specifically, in response to the request to intervene RTI as the driving automation level 3, it is not always possible for the driver to be in a state in which the brain arousal state is recovered and to return to a physical state that allows manual driving without numbness or the like in the body. If the transition from the driving automation level 4 to the driving automation level 3 is performed in such a case, there is a possibility that the situation goes beyond design ideas that has been assumed in advance in the vehicle control system, and there is a possibility that an accident or the like is induced if the driver is in a so-called dreaming state in which the driver has not yet sufficiently grasped all situations or in a stage where the situation awareness is still absent. Therefore, in the embodiment of the present disclosure, in order to reduce the possibility as the above, even in a stage where the vehicle control system side does not yet need to issue a request to intervene RTI to the driver (if normal situation awareness is present), a preventive dummy request to intervene RTI or pseudo control response task presentation may be performed as appropriate in order to confirm the return handling level (for example, arousal level) of the driver, and from response observation thereof, it is possible to observe an active response indicating the internal arousal recovery of the driver.

Note that each arrow indicating a transition between driving automation levels illustrated in FIG. 3 indicates a direction of the transition allowed to be autonomously performed, and a transition in the opposite direction of each arrow is not recommended since it causes the driver to erroneously recognize the state of the vehicle control system. That is, in the vehicle control system according to the embodiment of the present disclosure, it is desirable that it is designed not to autonomously return to the autonomous driving mode again without a proactive instruction from the driver in a case where a transition between driving automation levels has been performed in which the autonomous driving mode is automatically switched to the manual driving mode in which the driver intervenes. Imparting directivity (irreversibility) to switching the driving mode in this manner means that it is designed to prevent the autonomous driving mode from being set without a clear intention of the driver. Therefore, according to the vehicle control system, since the autonomous driving mode cannot be enabled only when the driver has a clear intention, it is possible to prevent the driver from misunderstanding, for example, that it is in the autonomous driving mode when it is not in the autonomous driving mode and easily start doing a secondary task.

As described above, in the embodiment of the present disclosure, in order to ensure safe traveling, switching from the autonomous driving mode to the manual driving mode is executed only when it is observed that the driver is in the internal recovery state.

### 4. CONFIGURATION EXAMPLE OF VEHICLE CONTROL SYSTEM

Next, a configuration example of a vehicle control system 11, which is an example of a mobile device control system to which the technology of the present disclosure is applied, will be described with reference to FIG. 4. FIG. 4 is a block diagram illustrating a configuration example of the vehicle control system 11 as an example of a mobile device control system to which the technology of the present disclosure is applied.

The vehicle control system 11 is included in a vehicle 1 and performs processing related to travel assistance and autonomous driving of the vehicle 1.

The vehicle control system 11 mainly includes a vehicle control electronic control unit (ECU) 21, a communication unit 22, a map information accumulating unit 23, a position information acquiring unit 24, an external recognition sensor 25, an in-vehicle sensor 26, a vehicle sensor 27, a storage unit 28, a travel assistance and autonomous driving control unit 29, a driver monitoring system (DMS) 30, a human-machine interface (HMI) 31, and a vehicle control unit 32.

The vehicle control ECU 21, the communication unit 22, the map information accumulating unit 23, the position information acquiring unit 24, the external recognition sensor 25, the in-vehicle sensor 26, the vehicle sensor 27, the storage unit 28, the travel assistance and autonomous driving control unit 29, the driver monitoring system (DMS) 30, the human-machine interface (HMI) 31, and the vehicle control unit 32 are communicably connected to each other via a communication network 41. The communication network 41 includes, for example, an in-vehicle communication network conforming to digital bilateral communication standards, such as a controller area network (CAN), a local interconnect network (LIN), a local area network (LAN), FlexRay (registered trademark), or Ethernet (registered trademark), a bus, or the like. The communication network 41 may be selectively used depending on the type of data to be transmitted. For example, a CAN may be applied to data related to vehicle control, and Ethernet may be applied to large-capacity data. Note that each unit of the vehicle control system 11 may be directly connected, not via the communication network 41, but by using wireless communication based on the premise of communication at a relatively short distance, such as near field communication (NFC) or Bluetooth (registered trademark).

Note that, hereinafter, in a case where each unit of the vehicle control system 11 performs communication via the communication network 41, description of the communication network 41 will be omitted. For example, in a case where the vehicle control ECU 21 and the communication unit 22 perform communication via the communication network 41, it is simply described that the vehicle control ECU 21 and the communication unit 22 perform communication.

The vehicle control ECU 21 includes, for example, various processors such as a central processing unit (CPU) or a micro processing unit (MPU). The vehicle control ECU 21 controls all or some of functions of the vehicle control system 11.

The communication unit 22 communicates with various devices inside and outside the vehicle, other vehicles, servers, base stations, and the like and transmits and receives various types of data. At this point, the communication unit 22 can perform communication using a plurality of communication schemes.

Communication that the communication unit 22 can execute with the outside of the vehicle will be schematically described. The communication unit 22 communicates with a server (hereinafter, referred to as an external server) or the like on an external network via a base station or an access point by a wireless communication scheme such as the 5th generation mobile communication system (5G), long term evolution (LTE), or dedicated short range communications (DSRC). The external network with which the communication unit 22 communicates is, for example, the Internet, a cloud network, a network unique to a company, or the like. The communication scheme performed by the communication unit 22 with an external network is not particularly limited as long as it is a wireless communication scheme capable of performing digital bidirectional communication at a communication speed equal to or higher than a predetermined speed and at a distance equal to or longer than a predetermined distance.

Furthermore, for example, the communication unit 22 can communicate with a terminal present in the vicinity of the host vehicle using the peer to peer (P2P) technology. The terminal present in the vicinity of the host vehicle is, for example, a terminal worn by a traveling body traveling at a relatively low speed such as a pedestrian or a bicycle, a terminal installed in a store or the like with a position fixed, or a machine type communication (MTC) terminal. Furthermore, the communication unit 22 can also perform V2X communication. The V2X communication refers to communication between the host vehicle and another party, such as vehicle to vehicle communication with another vehicle, vehicle to infrastructure communication with a roadside device or the like, vehicle to home communication, and vehicle to pedestrian communication with a terminal or the like carried by a pedestrian.

The communication unit 22 can receive, for example, a program for updating software for controlling the operation of the vehicle control system 11 from the outside (Over-the-Air). The communication unit 22 can further receive map information, traffic information, information around the vehicle 1, and others from the outside. Furthermore, for example, the communication unit 22 can transmit information regarding the vehicle 1, information around the vehicle 1, and others to the outside. Examples of the information of the vehicle 1 transmitted to the outside by the communication unit 22 include data indicating the state of the vehicle 1, a recognition result by a recognition unit 73, and others. Furthermore, for example, the communication unit 22 performs communication conforming to a vehicle emergency call system such as the eCall.

For example, the communication unit 22 receives an electromagnetic wave transmitted by the vehicle information and communication system (VICS) (registered trademark) such as a radio wave beacon, an optical beacon, or FM multiplex broadcasting.

Communication that the communication unit 22 can execute with the inside of the vehicle will be schematically described. The communication unit 22 can communicate with each device in the vehicle using, for example, wireless communication. The communication unit 22 can perform wireless communication with an in-vehicle device by a communication scheme capable of performing digital bidirectional communication at a communication speed equal to or higher than a predetermined speed by wireless communication, such as wireless LAN, Bluetooth, NFC, or wireless USB (WUSB). Without being limited thereto, and the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication scheme capable of performing digital bidirectional communication at a predetermined communication speed or higher by wired communication, such as the universal serial bus (USB), high-definition multimedia interface (HDMI) (registered trademark), or mobile high-definition link (MHL).

The device in the vehicle refers to, for example, a device not connected to the communication network 41 in the vehicle. As the device in the vehicle, for example, a mobile device or a wearable device carried by a passenger such as a driver, an information device brought into the vehicle and temporarily installed, and the like are conceivable.

The map information accumulating unit 23 accumulates one or both of a map acquired from the outside and a map created in the vehicle 1. For example, the map information accumulating unit 23 accumulates a three-dimensional high-precision map, a global map having lower accuracy than the high-precision map but covering a wide area, and others.

The high-precision map is, for example, a dynamic map, a point cloud map, a vector map, or the like. The dynamic map is, for example, a map including four layers of dynamic information, semi-dynamic information, semi-static information, and static information and is provided to the vehicle 1 from an external server or the like. The point cloud map is a map including point clouds (point cloud data). The vector map is, for example, a map in which traffic information such as lanes and positions of traffic lights are associated with a point cloud map and adapted to an advanced driver assistance system (ADAS) or autonomous driving (AD).

The point cloud map and the vector map may be provided from, for example, an external server or the like or may be created in the vehicle 1 as a map for performing matching with a local map to be described later on the basis of a sensing result by a camera 51, a radar 52, a LiDAR 53, or the like and accumulated in the map information accumulating unit 23. In addition, in a case where a high-precision map is provided from an external server or the like, for example, map data of several hundred meters square regarding a planned route on which the vehicle 1 travels from now is acquired from an external server or the like in order to reduce the communication capacity.

The position information acquiring unit 24 receives global navigation satellite system (GNSS) signals from GNSS satellites and acquires position information of the vehicle 1. The acquired position information is supplied to the travel assistance and autonomous driving control unit 29. Note that the position information acquiring unit 24 is not limited to the method using the GNSS signals and may acquire the position information using, for example, a beacon.

The external recognition sensor 25 includes various sensors used for recognition of a situation outside the vehicle 1 and supplies sensor data from each sensor to each unit of the vehicle control system 11. The external recognition sensor 25 may include any type and any number of sensors.

The external recognition sensor 25 mainly includes, for example, the camera 51, the radar 52, the light detection and ranging (laser imaging detection and ranging) (LiDAR) 53, and an ultrasonic sensor 54. Without being limited thereto, and the external recognition sensor 25 may include one or more types of sensors from among the camera 51, the radar 52, the LiDAR 53, and the ultrasonic sensor 54. The numbers of cameras 51, radars 52, LiDARs 53, and ultrasonic sensors 54 are not particularly limited as long as they can be practically installed in the vehicle 1. Furthermore, the types of sensors included in the external recognition sensor 25 is not limited to this example, and the external recognition sensor 25 may include other types of sensors. An example of the sensing area of each sensor included in the external recognition sensor 25 will be described later.

Note that the imaging method of the camera 51 is not particularly limited. For example, cameras of various imaging methods such as a time-of-flight (ToF) camera, a stereo camera, a monocular camera, and an infrared camera of imaging methods capable of ranging can be applied to the camera 51, as necessary. Without being limited thereto, the camera 51 may simply capture an image regardless of ranging.

Furthermore, for example, the external recognition sensor 25 can include an environment sensor for detecting the environment for the vehicle 1. The environment sensor is a sensor for detecting an environment such as the weather, the climate, or the brightness and can include various sensors such as a raindrop sensor, a fog sensor, a sunshine sensor, a snow sensor, and an illuminance sensor.

Furthermore, for example, the external recognition sensor 25 includes a microphone used for detection of sound around the vehicle 1, a position of a sound source, and the like.

The in-vehicle sensor 26 includes various sensors for detecting information inside the vehicle and supplies sensor data from the sensors to respective units of the vehicle control system 11. The type or the number of the various sensors included in the in-vehicle sensor 26 are not particularly limited as long as they can be practically installed in the vehicle 1.

For example, the in-vehicle sensor 26 can include one or more types of sensors of a camera, a radar, a seating sensor, a steering wheel sensor, a microphone, and a biological sensor. As the camera included in the in-vehicle sensor 26, for example, cameras of various imaging methods capable of ranging, such as a ToF camera, a stereo camera, a monocular camera, and an infrared camera, can be used. Without being limited thereto, the camera included in the in-vehicle sensor 26 may simply capture an image regardless of ranging. The biological sensor included in the in-vehicle sensor 26 is included, for example, on a seat, a steering wheel, or the like, and detects various types of biological information of an occupant such as a driver.

The vehicle sensor 27 includes various sensors for detecting the state of the vehicle 1 and supplies sensor data from the sensors to respective units of the vehicle control system 11. The type or the number of the various sensors included in the vehicle sensor 27 are not particularly limited as long as they can be practically installed in the vehicle 1.

For example, the vehicle sensor 27 mainly includes a speed sensor, an acceleration sensor, an angular velocity sensor (gyro sensor), and an inertial measurement unit (IMU) integrating these sensors. For example, the vehicle sensor 27 includes a steering angle sensor that detects the steering angle of the steering wheel, a yaw rate sensor, an accelerator sensor that detects an operation amount of the accelerator pedal, and a brake sensor that detects an operation amount of the brake pedal. For example, the vehicle sensor 27 includes a rotation sensor that detects the number of revolutions of the engine or the motor, an air pressure sensor that detects the air pressure of the tires, a slip rate sensor that detects the slip rate of the tires, and a wheel speed sensor that detects the rotation speed of the wheels. For example, the vehicle sensor 27 includes a battery sensor that detects the remaining amount and the temperature of the battery and an impact sensor that detects an external impact.

The storage unit 28 includes at least one of a nonvolatile storage medium or a volatile storage medium and stores data or a program. The storage unit 28 is used as, for example, an electrically erasable programmable read-only memory (EEPROM) and a random access memory (RAM), and a magnetic storage device such as a hard disc drive (HDD), a semiconductor storage device, an optical storage device, and a magneto-optical storage device can be applied as the storage medium. The storage unit 28 stores various programs and data used by each unit of the vehicle control system 11. For example, the storage unit 28 includes an event data recorder (EDR) and a data storage system for automated driving (DSSAD) and stores information of the vehicle 1 before and after an event such as an accident and information acquired by the in-vehicle sensor 26.

The travel assistance and autonomous driving control unit 29 controls travel assistance and autonomous driving of the vehicle 1. For example, the travel assistance and autonomous driving control unit 29 includes an analysis unit 61, an action planning unit 62, and an operation control unit 63.

The analysis unit 61 performs analysis processing of the situation of the vehicle 1 and the surroundings. The analysis unit 61 includes a self-position estimation unit 71, a sensor fusion unit 72, and the recognition unit 73.

The self-position estimation unit 71 estimates the self-position of the vehicle 1 on the basis of the sensor data from the external recognition sensor 25 and the high-precision maps accumulated in the map information accumulating unit 23. For example, the self-position estimation unit 71 generates a local map on the basis of the sensor data from the external recognition sensor 25 and estimates the self-position of the vehicle 1 by matching the local map with the high-precision map. The position of the vehicle 1 is based on, for example, the center of the axle of the pair of rear wheels.

The local map is, for example, a three-dimensional high-precision map created using technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated for every grid. The occupancy state of the object is indicated by, for example, the presence or absence or the presence probability of the object. The local map is also used for detection processing and recognition processing of a situation outside the vehicle 1 by the recognition unit 73, for example.

Note that the self-position estimation unit 71 may estimate the self-position of the vehicle 1 on the basis of the position information acquired by the position information acquiring unit 24 and the sensor data from the vehicle sensor 27.

The sensor fusion unit 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition unit 73 executes detection processing for detecting a situation outside the vehicle 1 and recognition processing for recognizing a situation outside the vehicle 1.

For example, the recognition unit 73 performs detection processing and recognition processing of a situation outside the vehicle 1 on the basis of information from the external recognition sensor 25, information from the self-position estimation unit 71, information from the sensor fusion unit 72, and others.

Specifically, for example, the recognition unit 73 performs detection processing, recognition processing, and the like of an object around the vehicle 1. The object detection processing is, for example, processing of detecting the presence or absence, the size, the shape, the position, the motion, and the like of an object. The object recognition processing is, for example, processing of recognizing an attribute such as the type of an object or identifying a specific object. However, the detection processing and the recognition processing are not necessarily clearly divided and may overlap with each other.

For example, the recognition unit 73 detects an object around the vehicle 1 by performing clustering of classifying point clouds based on sensor data by the radar 52, the LiDAR 53, or the like into groups of point clouds. As a result, the presence or absence, the size, the shape, and the position of an object around the vehicle 1 are detected.

For example, the recognition unit 73 detects the motion of an object around the vehicle 1 by performing tracking of following the motion of a group of a point cloud classified by the clustering. As a result, the speed and the traveling direction (travel vector) of the object around the vehicle 1 are detected.

For example, the recognition unit 73 detects or recognizes a vehicle, a person, a bicycle, an obstacle, a structure, a road, a traffic light, a traffic sign, road marking, and the like on the basis of image data supplied from the camera 51. Furthermore, the recognition unit 73 may recognize the type of the object around the vehicle 1 by performing recognition processing such as semantic segmentation.

For example, the recognition unit 73 can perform recognition processing of traffic rules around the vehicle 1 on the basis of the maps accumulated in the map information accumulating unit 23, an estimation result of the self-position by the self-position estimation unit 71, and a recognition result of an object around the vehicle 1 by the recognition unit 73. Through this processing, the recognition unit 73 can recognize the position and the state of the traffic light, the content of the traffic sign and the road marking, the content of the traffic regulations, travelable lanes, and the like.

For example, the recognition unit 73 can perform the recognition processing of the environment around the vehicle 1. As the surrounding environment to be recognized by the recognition unit 73, the weather, the temperature, the humidity, the brightness, the state of a road surface, and the like are conceivable.

The action planning unit 62 creates an action plan of the vehicle 1. For example, the action planning unit 62 creates an action plan by performing processing of global path planning and path tracking.

Note that the global path planning is processing of planning a rough path from the start to the goal. This global path planning is called a locus plan and includes processing of performing locus path planning (local path planning) that enables safe and smooth traveling in the vicinity of the vehicle 1 in consideration of the motion characteristics of the vehicle 1 in the planned path.

The path tracking is processing of planning an operation for safely and accurately traveling on the path planned by the global path planning within a planned time. For example, the action planning unit 62 can calculate a target speed and a target angular velocity of the vehicle 1 on the basis of the result of the path tracking processing.

The operation control unit 63 controls the operation of the vehicle 1 in order to implement the action plan created by the action planning unit 62.

For example, the operation control unit 63 controls a steering control unit 81, a brake control unit 82, and a drive control unit 83 included in the vehicle control unit 32 to be described later to perform acceleration and deceleration control and direction control in such a manner that the vehicle 1 travels on the locus calculated by the locus plan. For example, the operation control unit 63 performs cooperative control for the purpose of implementing the functions of the ADAS such as collision avoidance or impact mitigation, follow-up traveling, vehicle speed maintaining traveling, collision warning for the host vehicle, lane deviation warning for the host vehicle, and the like. The operation control unit 63 performs, for example, cooperative control intended for autonomous driving or the like in which the vehicle travels autonomously without depending on the operation of the driver.

The DMS 30 performs authentication processing of the driver, a recognition processing of the state of the driver, and the like on the basis of sensor data from the in-vehicle sensor 26, input data input to the HMI 31 to be described later, and others. As the state of the driver to be recognized, for example, the physical condition, the arousal level, the concentration level, the fatigue level, the line-of-sight direction, the drunkenness level, a driving operation, the posture, and the like are conceivable. Furthermore, the DMS 30 may perform the authentication processing of the driver, the recognition processing of the state of the driver, and the like by referring to a sleep disorder having a risk of affecting driving, a medical history leading to consciousness disorder or insufficient sleep, some life record information, and the like.

Note that the DMS 30 may perform authentication processing of a passenger other than the driver and recognition processing of the state of the passenger. Furthermore, for example, the DMS 30 may perform recognition processing of the situation inside the vehicle on the basis of sensor data from the in-vehicle sensor 26. As the situation inside the vehicle to be recognized, for example, the temperature, the humidity, the brightness, the odor or the sent, and the like are conceivable.

The HMI 31 inputs various types of data, instructions, and the like and presents the various types of data to the driver and others.

Data input by the HMI 31 will be schematically described. The HMI 31 has an input device for a person to input data. The HMI 31 generates an input signal on the basis of data, an instruction, or the like input by the input device and supplies the input signal to each unit of the vehicle control system 11. The HMI 31 includes an operator such as a touch panel, a button, a switch, or a lever as the input device. Without being limited thereto, the HMI 31 may further include an input device capable of inputting information by a method other than manual operation such as by voice, a gesture, or others. Furthermore, the HMI 31 may use, for example, a remote control device using infrared rays or radio waves or an external connection device such as a mobile device or a wearable device supporting the operation of the vehicle control system 11 as an input device.

Presentation of data by the HMI 31 will be schematically described. The HMI 31 generates visual information, auditory information, and tactile information for the passengers or the outside of the vehicle. In addition, the HMI 31 performs output control for controlling output, output content, output timing, an output method, and others of each piece of information that is generated. The HMI 31 generates and outputs, as the visual information, information indicated by images or light such as an operation screen, state display of the vehicle 1, warning display, or a monitor image indicating a situation around the vehicle 1. Furthermore, the HMI 31 generates and outputs information indicated by sounds such as a voice guidance, a warning sound, or a warning message as the auditory information. Furthermore, the HMI 31 generates and outputs, as the tactile information, information given to the tactile sense of the passengers by, for example, a force, vibrations, a motion, or the like.

As an output device with which the HMI 31 outputs the visual information, for example, a display device that presents the visual information by displaying an image thereon or a projector device that presents the visual information by projecting an image are applicable. Note that the display device may be a device that displays the visual information in the field of view of the passengers such as a head-up display, a transmissive display, or a wearable device having an augmented reality (AR) function other than a display device having a normal display. In addition, the HMI 31 can use display devices included in a navigation device, an instrument panel, a camera monitoring system (CMS), an electronic mirror, a lamp, or the like included in the vehicle 1 as an output device that outputs the visual information.

As an output device from which the HMI 31 outputs the auditory information, for example, an audio speaker, headphones, or earphones are applicable.

As an output device to which the HMI 31 outputs the tactile information, for example, a haptics element using haptic technology is applicable. The haptics element is provided, for example, at a portion with which a passenger of the vehicle 1 comes into contact, such as a steering wheel or a seat.

Note that the output device that outputs the auditory information, the output device that outputs the tactile information, and the like may emit abnormal noise or abnormal vibration imitating abnormal noise that would occur when the vehicle 1 is in a failure situation in a case where a partial defect is found in the system self-diagnosis of the vehicle 1 or in a case where periodic maintenance of the vehicle 1 is prompted, in addition to being used as normal information notification means to the driver. in this manner, the output device that outputs the auditory information, the output device that outputs the tactile information, and the like described above can be used as an extension as an HMI that is one of information transmission means for preventing a notification such as a lamp like a tell-tail from being disregarded by the user.

The vehicle control unit 32 controls each unit of the vehicle 1. The vehicle control unit 32 mainly includes the steering control unit 81, a brake control unit 82, the drive control unit 83, a body system control unit 84, a light control unit 85, and a horn control unit 86.

The steering control unit 81 detects and controls the state of the steering system of the vehicle 1. The steering system includes, for example, a steering mechanism including a steering wheel and the like, an electric power steering, and the like. The steering control unit 81 includes, for example, a steering ECU that controls the steering system, an actuator that drives the steering system, and others.

The brake control unit 82 detects and controls the state of the brake system of the vehicle 1. The brake system includes, for example, a brake mechanism including a brake pedal, an antilock brake system (ABS), a regenerative brake mechanism, and the like. The brake control unit 82 includes, for example, a brake ECU that controls the brake system, an actuator that drives the brake system, and the like.

The drive control unit 83 detects and controls the state of the drive system of the vehicle 1. The drive system includes, for example, a driving force generation device for generating a driving force such as an accelerator pedal, an internal combustion engine, and a driving motor, a driving force transmission mechanism for transmitting the driving force to wheels, and others. The drive control unit 83 includes, for example, a drive ECU that controls the drive system, actuators that drive the drive system, and others.

The body system control unit 84 detects and controls the state of a body system of the vehicle 1. The body system includes, for example, a keyless entry system, a smart key system, a power window device, a power seat, an air conditioner, an airbag, a seat belt, a shift lever, and others. The body system control unit 84 includes, for example, a body system ECU that controls the body system, actuators that drive the body system, and others.

The light control unit 85 detects and controls states of various lights of the vehicle 1. As the lights to be controlled, for example, a headlight, a backlight, a fog light, a turn signal, a brake light, projection, display on a bumper, and the like are conceivable. The light control unit 85 includes a light ECU that controls the lights, actuators that drives the lights, and the like.

The horn control unit 86 detects and controls the state of the car horn of the vehicle 1. The horn control unit 86 includes, for example, a horn ECU that controls the car horn, an actuator that drives the car horn, and the like.

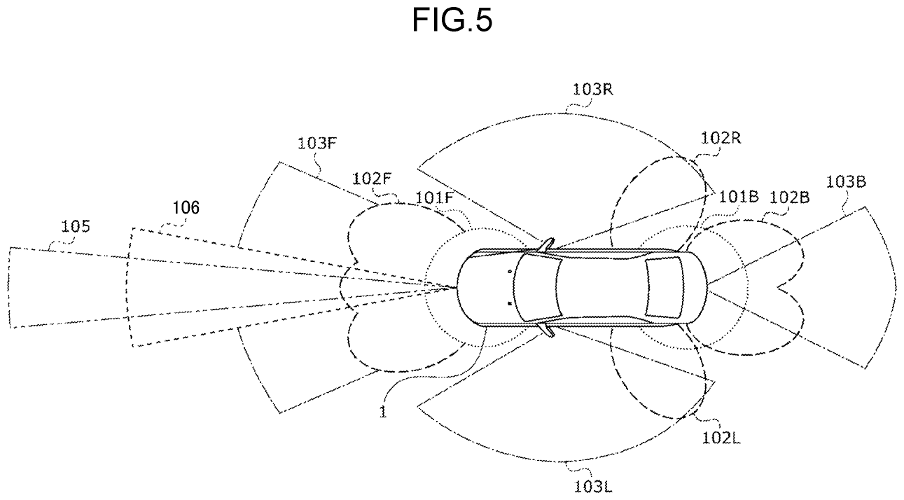

FIG. 5 is a diagram illustrating an example of sensing areas by the camera 51, the radar 52, the LiDAR 53, the ultrasonic sensor 54, or others of the external recognition sensor 25 in FIG. 4. Note that FIG. 5 schematically illustrates the vehicle 1 as viewed from above, in which the left end side is the front end (front) side of the vehicle 1, and the right end side is the rear end (rear) side of the vehicle 1.

A sensing area 101F and a sensing area 101B indicate examples of sensing areas of the ultrasonic sensor 54. The sensing area 101F covers the periphery of the front end of the vehicle 1 by a plurality of ultrasonic sensors 54. The sensing area 101B covers the periphery of the rear end of the vehicle 1 by a plurality of ultrasonic sensors 54.

Sensing results in the sensing area 101F and the sensing area 101B are used, for example, for parking assistance of the vehicle 1.

A sensing area 102F or a sensing area 102B indicates an example of a sensing area of the radar 52 for a short distance or a middle distance. The sensing area 102F covers up to a position farther than the sensing area 101F ahead of the vehicle 1. The sensing area 102B covers up to a position farther than the sensing area 101B behind the vehicle 1. A sensing area 102L covers the rear periphery of the left side face of the vehicle 1. A sensing area 102R covers the rear periphery of the right side face of the vehicle 1.

A sensing result in the sensing area 102F is used, for example, to detect a vehicle, a pedestrian, or the like present ahead of the vehicle 1. A sensing result in the sensing area 102B is used, for example, for a collision prevention function or the like behind the vehicle 1. Sensing results in the sensing area 102L and the sensing area 102R are used, for example, for detecting an object in a blind spot on the sides of the vehicle 1.

A sensing area 103F or a sensing area 103B indicates examples of a sensing area by the camera 51. The sensing area 103F covers up to a position farther than the sensing area 102F ahead of the vehicle 1. The sensing area 103B covers up to a position farther than the sensing area 102B behind the vehicle 1. A sensing area 103L covers the periphery of the left side face of the vehicle 1. A sensing area 103R covers the periphery of the right side face of the vehicle 1.

A sensing result in the sensing area 103F can be used for, for example, recognition of a traffic light or a traffic sign, a lane deviation prevention assist system, and an automatic headlight control system. A sensing result in the sensing area 103B can be used for, for example, parking assistance and a surround view system. Sensing results in the sensing area 103L and the sensing area 103R can be used for the surround view system, for example.

A sensing area 106 indicates an example of a sensing area of the LiDAR 53. The sensing area 106 covers up to a position farther than the sensing area 103F ahead of the vehicle 1. Meanwhile, the sensing area 106 has a narrower area in the left-right direction than that of the sensing area 103F.

A sensing result in the sensing area 106 is used, for example, for detecting an object such as a surrounding vehicle.

A sensing area 105 indicates an example of a sensing area of the radar 52 for a long distance. The sensing area 105 covers up to a position farther than the sensing area 106 ahead of the vehicle 1. Meanwhile, the sensing area 105 has a narrower area in the left-right direction than that of the sensing area 106.

A sensing result in the sensing area 105 is used for, for example, adaptive cruise control (ACC), emergency braking, collision avoidance, and the like.

Note that the sensing areas of the sensors of the camera 51, the radar 52, the LiDAR 53, and the ultrasonic sensor 54 included in the external recognition sensor 25 may have various configurations other than those in FIG. 5. Specifically, the ultrasonic sensor 54 may also perform sensing on the sides of the vehicle 1, or the LiDAR 53 may perform sensing behind the vehicle 1. In addition, the installation positions of the sensors are not limited to the examples described above. The number of sensors may be one or more.

### 5. BACKGROUND OF CREATION OF EMBODIMENTS OF PRESENT DISCLOSURE

First, before describing the embodiment of the present disclosure, the background that led to creation of the embodiment of the present disclosure by the present inventors will be described.

In the conventional autonomous driving described above, it is based on the premise that the vehicle control system has functional performance capable of performing driving automation levels 3 or 4 capable of performing all the control of the vehicle 1 and causing the vehicle 1 to autonomously travel. Moreover, in the conventional autonomous driving, when the control capability of the vehicle control system reaches a situation where the driving automation levels 3 or 4 cannot be executed, the subject of the control of the vehicle 1 is returned to the driver. Furthermore, in a situation where even such an operation cannot be performed, it is based on the premise that the vehicle 1 is urgently stopped by control called the MRM or MRC.

In particular, the autonomous driving technology has been developed for control of autonomous driving that enables a level at which a driver can perform secondary tasks unrelated to driving steering while traveling. In a stage where an autonomous driving system cannot safely execute such cognitive determination steering control that can complete an entire travel plan the autonomous driving, there occurs a situation in which the driver as a human takes over the driving. Furthermore, in a case where the takeover cannot be performed, an emergency stop, an emergency deceleration, or the like is executed; however, execution of an emergency stop or the like may induce traffic congestion or an accident involving surrounding vehicles. Therefore, in order to avoid such an accident or the like, the autonomous driving system is required to have extremely high performance of cognitive determination control, and it is also required to provide an HMI for executing reliable and prompt takeover to the driver.

Furthermore, in the conventional autonomous driving, vehicle control systems, road infrastructures, systems, and others are designed on the premise that vehicles are used by the able-bodied persons. That is, the designed is not based on the premise that a disabled person uses the vehicle 1. Specifically, in a case where the control capability of the vehicle control system reaches a situation where the driving automation level 3 or 4 cannot be executed, it is based on the premise that a driver who is a disabled person cannot handle the situation, and thus, it is based on the premise that the disabled persons cannot use the autonomous driving technology. In addition, it is also conceivable to limit the area of use of the autonomous driving by the disabled persons to the low-speed driving zones in order for the disabled persons to use the autonomous driving; however, this also leads to limiting the life zones of the disabled persons to those areas, and thus the present inventors think that a new mechanism is necessary for the disabled persons to benefit from the autonomous driving technology. Meanwhile, there are cases where some disabled persons can perform steering (use of autonomous driving) only by modifying the vehicle 1 for normal able-bodied persons. However, in general, since it is extremely difficult to steer the vehicle 1, it is conceivable that it is difficult for the disabled persons to use autonomous driving as a free means of travel that requires intervention in user's steering control. Therefore, in view of such a situation, the present inventors have intensively studied autonomous driving technology for disabled persons.

During the study, the present inventors focused on a fact that a situation in which an autonomous driving system requests a driver to return to driving (steering) is a situation in which control behavior determination cannot be executed by learning using artificial intelligence of a general level. Moreover, the present inventors have uniquely found that such situations include many situations that can be handled if the control is performed by the autonomous driving system by following the driver's intelligent determination. Specifically, the autonomous driving system is not good at a stage related to determination among the stages of cognition (perception), determination (situation understanding), and control (operation) of the processing related to steering as compared to a human driver. More specifically, the autonomous driving system is inferior to humans in estimating a result slightly ahead that may occur in a case where an operation (control) is performed with understanding of the situation and choosing final operation (control) option on the basis of the estimation. Therefore, the present inventors have come to understand that the autonomous driving system can continue traveling without executing an emergency stop or the like by achieving cooperation between the driver and the autonomous driving system through human compensation for the stage related to the determination, namely, by intervention of the driver, as a human, in the determination. Moreover, the present inventors have created the embodiment of the present disclosure described below on the basis of such an original viewpoint. The largest difference in the operation is that, in a case where the autonomous driving system gives up traveling at level 4, the steering control cannot be directly performed by the user in a case where the user is a disabled person, and thus there is no choice for the vehicle 1 but to forcibly shift to accident damage minimization processing called MRM or MRC. Therefore, before entering such a situation, the user needs to finish providing information that is necessary for the selection determination in advance at a stage before there is no options of handling so that the user can make the best avoidance selection determination. This is because otherwise, the user may not be able to make an appropriate determination in a timely manner and may enter a section in which there are no options. Furthermore, at this point, for displaying options, a mechanism that is designated and set by the user in advance may be adopted. Alternatively, a mechanism that presents a recommended option suitable for the user from the autonomous driving system, a controller, or the like may be adopted. Furthermore, various settings may be made for function selection such as giving priority to a time of arrival at a destination, giving priority to intervention steering, or the like.

In the embodiment of the present disclosure created by the present inventors, a human makes determination before the autonomous driving system does system, the determination that humans are more capable of than the system, and the system provides control based on the human determination under human monitoring. With this configuration, even in a case where a disabled person has difficulty or takes time in steering, it is possible to handle various situations, that is, it is possible to expand the situation that the disabled person can handle. For example, according to the embodiment of the present disclosure, even in a case where the latest LDM that is constantly updated by an infrastructure is not provided to the autonomous driving system (or temporarily interrupted), it is possible to cause the vehicle 1 to automatically travel. At first glance, this is control similar to the control of the driving automation level 3 defined by the SAE; however, it is greatly different in that the autonomous driving system is responsible for stages of cognition (perception), determination (situation understanding), and control (operation) when an able-bodied person uses the driving automation level 3, whereas a human (driver) is responsible for the stage of determination in the present embodiment.

Meanwhile, in the use of the autonomous driving by a disabled person, unlike in the normal use of the autonomous driving by an able-bodied person, in a case where the autonomous driving system cannot take measures, the driver cannot take an emergency measure or the like due to lack of a physical function equivalent to that of an able-bodied person, and thus, there is a possibility that the number of times of activating the MRM or the MRC is inevitably increased. Therefore, if the operation is set in such a manner that the user does not easily allow to perform the MRM or the MRC, the use of the disabled persons is not allowed even if the vehicle 1 has the autonomous driving function. That is, for the disabled persons, there is a great psychological pressure that a means of travel cannot be secured. In addition, if a disabled person excessively depends on the autonomous driving system, the disabled person cannot handle manual driving in an emergency situation. Therefore, even during the autonomous driving by the autonomous driving system, reduced attention of the driver to the driving directly leads to an increased risk. That is, in a case where the able-bodied person continuously uses the autonomous driving mode at the driving automation level 3 and in a case where the disabled person continuously uses the autonomous driving, the behavioral psychology that falls into attention reduction that requires handling of an event is greatly different, and it is conceivable that a heavy burden is imposed on the disabled person. However, the present inventors conceive that there may be an option of using autonomous driving while continuously paying attention in order to benefit from free traveling as long as a disabled person can secure a means of travel even though a heavy burden is incurred.

Furthermore, even if a disabled person cannot perform direct steering (for example, quick turning of the steering wheel, and the like), the disabled person can input an instruction accompanied by determination necessary for steering to the autonomous driving system via an HMI in a form replacing accelerator and brake pedals or a steering wheel. For example, it is conceivable that, with the disabled person as the driver feeding back determination based on prediction information to the autonomous driving system via voice, a gesture, or a joystick operation, the autonomous driving system can take a countermeasure faster as compared to the conventional manual driving return required for an able-bodied person as a driver at the driving automation level 3. That is, the embodiment of the present disclosure is based on an idea different from the use in the conventional driving automation levels 3 and 4 defined by the SAE and is based on the premise that the autonomous driving system performs monitoring (cognition) and control necessary for determination and control but allows intervention of an intention and an operation control instruction of the user at the stage of determination (situation understanding).

In other words, in the embodiment of the present disclosure, while main vehicle control is automatically performed by the autonomous driving system, the user as the disabled person inputs, to the autonomous driving system, determination regarding a situation slightly ahead that the autonomous driving system cannot autonomously determine. By doing so, in the embodiment of the present disclosure, the autonomous driving system can take measures on the basis of the determination of the user who is a disabled person.

Of course, under the present circumstances, it is considered that it is difficult to expand the use of autonomous driving to totally blind users, and this is not a realistic use form. However, in the embodiment of the present disclosure, even in a case where the user is a disabled person, if the user has at least visual ability and unerring determination ability and can instruct the autonomous driving system via voice, a gesture, a joystick operation, or the like, it is possible to use autonomous driving under specific limitations even though it is difficult to physically and directly operate a steering interface (for example, a steering wheel). That is, according to the embodiment of the present disclosure, it is possible to enable many people to benefit from the autonomous driving.

Note that, in the use of the autonomous driving on the premise of the low-speed traveling, even if the visual ability is not at a level at which quick and agile determination can be performed, if the surrounding situation determination can be appropriately performed with a little time, and instruction input can be further performed, the vehicle 1 can pass through a section, although it takes extra time, and can perform the function as a means of travel.

In addition, as in this example, there are various ways of assist required by a disabled person, and thus, the function and the form of instruction to be provided by the vehicle 1 can be selected as appropriate depending on the disabled person. That is, in the present embodiment, since the form of a function or an instruction provided by the vehicle 1 needs to be customized for each individual, it is desirable to have a configuration in which the setting of the HMI 31 and the function provision are parameterized to make it possible to freely set to match with the characteristics of the individual.

As described above, the embodiment of the present disclosure created by the present inventors is an embodiment related to a mechanism that enables a disabled person to use the autonomous driving technology, and at the same time, it is possible to minimize the risks that the autonomous driving causes congestion, a rear-end accident, or the like through such use.

### 6. EMBODIMENTS

### <6.1 Use Situations>

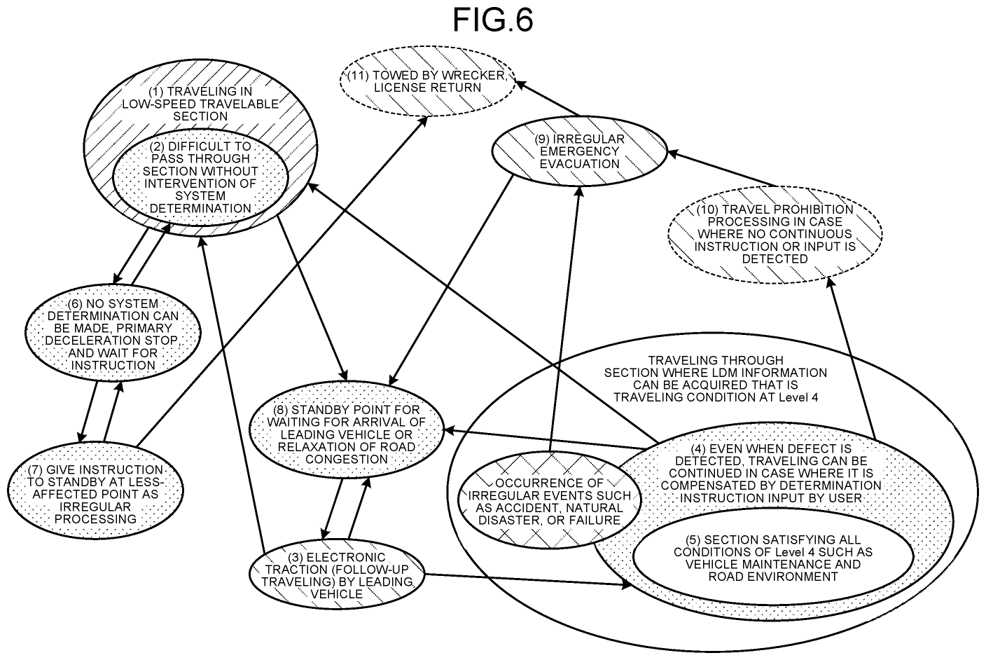

First, use situations of autonomous driving will be described with reference to FIG. 6. FIG. 6 is an explanatory diagram for explaining use situations of autonomous driving.

As illustrated in FIG. 6, there are various forms of use of the autonomous driving in the present embodiment, and the use form and the action to be performed by the user vary depending on the situation. For example, in (1), (3), and (5) in FIG. 6, since the autonomous driving system and the leading vehicle mainly execute determination, control, and the like, it is unnecessary for the user to constantly pay attention to the front. On the other hand, in (2) and (4) in FIG. 6, the user has the duty of constantly paying attention to the front and executes control of the vehicle 1 by inputting, to the autonomous driving system, determination that is difficult in the autonomous driving system, such as an instruction of any one of stop, deceleration, or traveling on the right or left of the vehicle, an overtaking instruction, an overtaking standby instruction, a traffic signal waiting instruction, a pedestrian waiting instruction, a before-crossing standby instruction, a standby instruction for road parking, or a standby instruction for moving to the right or left. For example, the user confirms pairing of a candidate vehicle that can be a leading vehicle and further gives an instruction on entry to a standby point such as a service area to wait for the paired vehicle ((8) in FIG. 6). In addition, in the use mode of (4) of FIG. 6, when the user grasps in advance that there is a point that is difficult to pass at the destination, the user gives an instruction to move to a low-speed travelable section before the point where an event of difficult-to-pass section occurs ((1) of FIG. 6), instructs the leading vehicle to stand by, and the like. At this point, the user does not directly input an instruction to an actuator necessary for steering as a steering command but inputs a medium- to long-term determination result for the autonomous driving system to control the actuator via the HMI.

That is, one of the features of the embodiment of the present disclosure is to have a new mode that is neither the driving automation level 3 nor the driving automation level 4 defined by the SAE. Note that, in the present embodiment, since the user cannot directly execute agile accident avoidance steering that an able-bodied person is deemed to be capable of handling, determination requiring urgency is left to the autonomous driving system, and the user focuses on making determination and issuing an instruction before the urgency approaches. Therefore, the present embodiment has a mechanism in which the user can issue an emergency brake start instruction before, for example, a threshold value for initiation of emergency brake operation that is executed by the autonomous driving system to take measures at an early stage.

In any case, the user needs some information for making determination, and appropriate determination cannot be made without information. Therefore, it is effective to provide information that leads to the determination in addition to determination made by the user by directly looking at the forward route, and a presentation method thereof is not limited. That is, it is necessary to devise to work on the intention of the user at an early stage and to promote an unerring determination at an early stage. Here, the important thing for the disabled person is that, in a case where the disabled person cannot physically perform direct steering control such as the use at the level 3 by an able-bodied person, what type of options are there up to which point before the vehicle 1 advances to a situation where the vehicle 1 cannot take a motion of autonomous traveling depending on the road situation, the presence or absence of a leading vehicle, availability of a remote assist operator, and the like. That is, in the prediction information content generation, it is effective to provide the information having advance determination predictability, and it is desirable to visually provide information indicating approach of the occurrence point. Details will be described later.

Furthermore, in the present embodiment, use forms based on the premise that the user mainly issues an instruction will be mainly described. However, a service in a limited area and use of a person with severe disability are also possible. For example, a remote steering operator may partially provide assistance as necessary. In addition, when assignment (pairing) processing of the operator is performed in a management center, convenience may be further improved by providing a combination with a concierge service provided by a human controller, a virtual controller by an information processing device, or the like.

In addition, as a condition for being a leading vehicle in (3) of FIG. 6, the convenience is further enhanced by devising upon operation by, for example, in a form of appropriately responding to a request from a following vehicle, for each leading vehicle request, selecting a vehicle in which the traveling speed is appropriately adjusted, the score of safe driving is high, the possibility of completing a reserved section is high, the abandonment frequency of a prior leading section is low, and the probability of adhering to a desired arrival time is high. For such a leading vehicle, an incentive such as reduction or exemption of the automobile tax may be provided depending on each evaluation as described above, the number of times of assist, and others. Meanwhile, the leading vehicle may be operated by a registered volunteer who has received training of a vehicle owned by a general individual through collection of a user fee or collecting a certain fee by subscription or the like or may be operated by a normal taxi company having more specialized knowledge, one of forms of substitute driver services, or the like.

Furthermore, in (4) of FIG. 6, for example, it is preferable that various types of information are displayed on a front windshield in the front field of view of the user by a head-up display function provided by the present embodiment.

### <6.2 Cognition, Determination, and Operation>

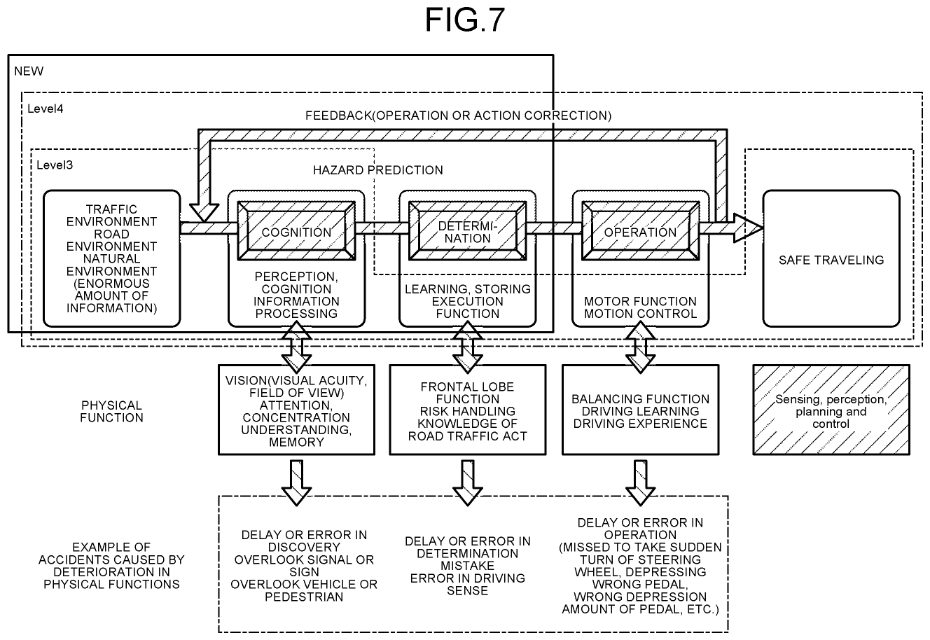

Next, cognition, determination, and operation in autonomous driving will be described with reference to FIG. 7. FIG. 7 is an explanatory diagram for explaining cognition, determination, and operation in autonomous driving.

In the driving automation level 4 defined by the conventional SAE, an autonomous driving system substitutes all of the driving steering in a limited area satisfying a specific traveling environmental condition. Therefore, at the driving automation level 4, the autonomous driving system executes all of recognition, determination, and operation as enclosed by a two-dot chain line in FIG. 7.

Meanwhile, in the driving automation level 3 defined by the conventional SAE, although the autonomous driving system substitutes all of the driving steering in a limited area satisfying a specific traveling environmental condition, when there is a possibility that the autonomous driving system does not operate normally during the operation of the autonomous driving system, a warning for prompting to drive is issued to the user, and thus the user needs to appropriately respond and to steer. Therefore, at the driving automation level 3, the autonomous driving system is based on the premise that the user who has received a takeover request from the autonomous driving system executes all of the recognition, determination, and operation takeover despite that the MRM or MRC function may be limitedly executed in order to minimize the risk in a case where the user does not take or is delayed to take appropriate countermeasures as a part of the recognition, determination, and operation as enclosed by a broken line in FIG. 7.

In the new driving automation level proposed in the embodiment of the present disclosure, contrary to the driving automation levels 3 and 4 described above, while the autonomous driving system travels in a state of substituting all of the driving steering in a limited area satisfying a specific traveling environmental condition in which the driving automation level 4 is allowed, the user constantly monitors (the user continues the attention duty) so as to receive the information (information of approach) provided by the autonomous driving system regularly and in advance, issues a handling instruction to the autonomous driving system so that the vehicle 1 does not need to take an unreasonable emergency stop or emergency evacuation action, and selectively uses the autonomous driving function on the basis of a plurality of pieces of advance candidate information that can be taken, instead of leaving the autonomous driving function to the determination by the autonomous driving system. In other words, in the new driving automation level proposed in the present embodiment, the user constantly grasps the situation, predicts the result in advance, and inputs an option for taking an appropriate countermeasure to the autonomous driving system as an instruction, thereby suppressing the occurrence of a situation in which an emergency measure is likely to be taken if it is the autonomous driving system alone. That is, the new driving automation level proposed in the embodiment is a use form different from the so-called driving automation level 4 defined in the related art. Therefore, at this level, the user executes cognition and determination as enclosed by a solid line in FIG. 7, and the user is responsible for giving an instruction on the medium- to long-term determination. If such operations frequently occur that the user disregards monitoring the situation and enters a blind alley by depending excessively on the autonomous driving system or forcibly enters a road having a narrow width that allows only one vehicle to pass despite that an oncoming vehicle is approaching and thereby interrupts the passage, social acceptability is lost.

In addition, the case where the autonomous driving system performs all the determination and operations at this new driving automation level is limited to a case of emergency. In the present embodiment, for example, in a case where a remaining time until a collision is less than a predetermined time, such as a case where the collision with an obstacle is imminent, the autonomous driving system executes an emergency treatment without waiting for a determination instruction of the driver.

Note that, in general, when a person drives a car, the person unconsciously captures various types of information that can be obstacles on roads and other surrounding areas, pays attention depending on the saliency of the information, and if there is a subject that seems to pose a risk, in many cases, the person checks the subject to determine an optimal countermeasure. The user further estimates a situation predicted as a result of the countermeasure and then performs the final countermeasure. Although there are some determination such as steering to avoid sudden jumping out from a place outside the field of view of the driver or instantaneous reflective handling due to a slip on a road surface, most of the driver's determinations are made in the above-described flow. That is, the driver unconsciously grasps the surroundings in advance, coping controls handling on the basis of the grasped surroundings, predicts a result of the handling control, unconsciously keeps the balance, and makes the most desirable choice in order not to increase the risk.

Incidentally, keeping the balance means that, for example, making a choice whether to intentionally attempt an unreasonable stop by applying sudden braking when a traffic light turns into a yellow signal on a road surface with rain or covered with snow or to pass in a case where the vehicle speed of the host vehicle is not sufficiently low by avoiding the unreasonable stop by comparing the advantages brought by the stop by applying the sudden braking and the disadvantages that a slip occurs due to the sudden braking operation or that a rear-end accident by a following vehicle occurs. Of course, it is not always necessary to implement the future prediction farther than the immediate future through all the thought processes, and the predictability increases as long as there is combination information combining information of occurrence of future results. Therefore, there are cases where the combination of relevant information gives predictability to a rather far future in human behavior determination. That is, for example, a driver who is not accustomed to a snowy land improves the result predictability under the condition where the driver is placed through experience by instinctively grasping the vehicle speed at which slip is likely to occur and the time or distance it takes until the vehicle stops.

The autonomous driving system makes various determinations apart from the traffic rules, such as recognizing an accident site on a distant road, predicting a heavy rain from the way a rain cloud is approaching ahead on the route, giving a way to an oncoming vehicle since it is difficult for vehicles to pass each other in a narrow section under construction, or passing while deviating to the opposite lane in a section under construction, in balance with an influence brought by a long-term result thereof. In other words, in the operation of the traffic society by manual driving, in a situation where there is a risk of hindering smooth social activity if strict operation bound by these strict traffic rules is performed, there are cases where blocking the passage is prevented by giving way despite the priority to pass first according to the situation determination of the user on site or by advancing first when given a way even when the rules require to stop the vehicle. In order to solve these troubles, it is not necessary to take charge of the entire steering of the vehicle 1. It is also possible to prevent the occurrence of the problem itself in advance by performing selection determination or by further performing selection determination at an early stage in advance.

### <6.3 Exemplary Case of User Intervention>

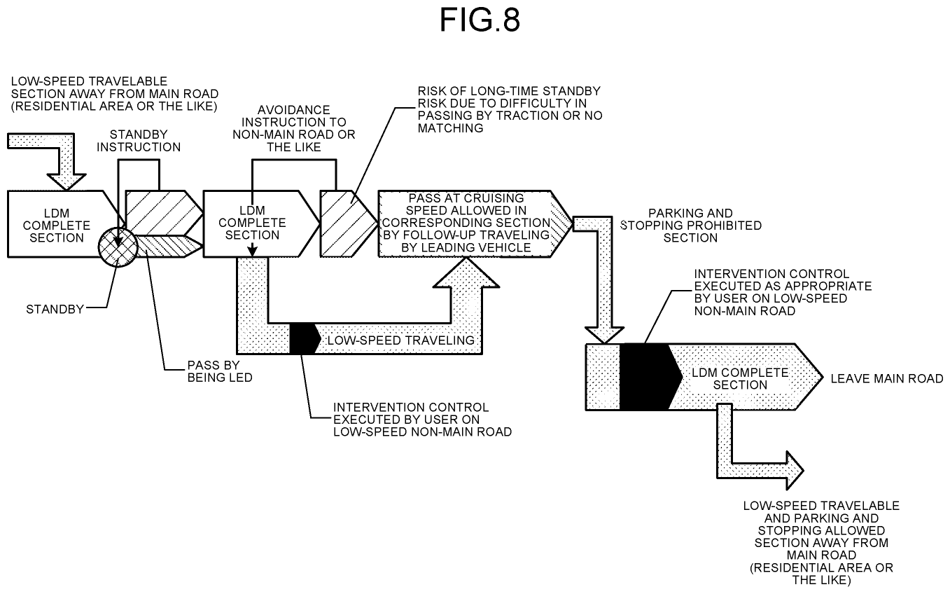

Next, an exemplary case of user intervention in the present embodiment will be described with reference to FIG. 8. FIG. 8 is an explanatory diagram for explaining an exemplary case of user intervention in the embodiment of the present disclosure.

In the case of traveling at the driving automation level 4 defined in the SAE, in order to ensure safe traveling, it is necessary for necessary related equipment (sensors or the like that perceive the surrounding environment) to execute environment recognition with redundancy, and it is necessary that conditions are satisfied such as weather conditions, road conditions, and that there is no deterioration in the recognition due to contamination of the sensors or the like. Therefore, for example, when it becomes, even slightly, difficult to detect a road sign or a lane, information necessary for driving determination lacks, and thus driving at the driving automation level 4 becomes no longer possible. At this point, the user takes over the driving steering as the driving automation level 3 defined by the SAE. However, in a case where the user cannot take over the driving steering, the vehicle 1 has to make an emergency stop or the like on the spot in the conventional autonomous driving mechanism.

However, as described above, there are many situations where continuous traveling is possible only by inputting determination information to the autonomous driving system at an early stage without the user directly controlling (steering) the actuators or the like of the vehicle 1. For example, in the case of a failure of a raindrop sensor, a road surface freezing detection sensor, an image sensor, or the like mounted on the autonomous driving system, or in the case of a malfunction of a communication device such as that LDM information necessary for traveling by full driving automation cannot be acquired in advance, it is expected that continuous traveling can be performed by an unerring determination instruction by the user.

Therefore, in the embodiment of the present disclosure, the user constantly grasps the situation, the autonomous driving system indicates options at an early stage on the basis of certain rules, and the user predicts a result in advance on the basis of the grasped situation, selects the best option from the indicated options, and inputs the selected option to the autonomous driving system. Then, the autonomous driving system controls the vehicle 1 in accordance with the option that has been input. Note that, in the present embodiment, it is based on the premise that the user cannot be expected to manually steer the vehicle 1 promptly due to physical restrictions. Therefore, the present embodiment is limited to use within a range in which there is enough time to give instructions, and autonomous driving can be used safely even with such mild and slow instructions. In a high-speed travel section in which agile steering handling is required, in a case where the vehicle attempts to enter a section in which conditions are not met on the basis of the presence or absence of a leading vehicle, the update completion situation of the LDM, evacuation to a road side, or the presence or absence of an evacuation road side or the congestion level thereof, the vehicle waits for the leading vehicle at a standby point before entering the section or changes the route planning to a road on which the vehicle can travel at a low speed.

For example, as illustrated in FIG. 8, in the present embodiment, for example, in a case where the vehicle travels from a low-speed travelable section to an LDM complete section (first section), traveling by the autonomous driving system is possible. However, in a case where the LDM complete section is interrupted, or in a section (second section) in which it is difficult to take a countermeasure such as stopping the vehicle at a safe road side or the like due to a change such as a decreased number of lanes of a road or that a road side is occupied by a vehicle in an accident, a construction vehicle, or the like in a subsequent section, for example, the user recognizes in advance that the LDM complete section will be interrupted and, for example, by intervening by giving an instruction to the autonomous driving system such as using a leading vehicle or waiting for the leading vehicle, makes it possible to continue traveling despite a temporary standby. In addition, as illustrated in FIG. 8, in a case where it is difficult to perform electronic traction by the leading vehicle while the user recognizes in advance that the LDM complete section will be interrupted or in a case where there is a risk in waiting for a long time or the like since pairing with the leading vehicle cannot be performed, an instruction, to escape to a low-speed travelable section where the user himself/herself can perform control, may be issued in advance. In the present specification, the first section is a section in which automatic steering based on determination by the autonomous driving system is allowed and is specifically, for example, an ODD section. On the other hand, the second section is, for example, a section in which the automatic steering based on determination by the autonomous driving system is not allowed, which means a section in which traveling is made possible with the user making determinations instead. Specifically, the second section is, for example, a section out of the ODD sections.

Note that, in a low-speed travelable section, even when the vehicle 1 decelerates, travels at a low speed, or stops, it is conceivable that obstruction to the following vehicles is limited. At least, social acceptance is likely to be obtained since this does not lead to significant inhibition of social activities as compared with a traffic congestion or traffic obstruction on a main road.

Meanwhile, in the present embodiment, by performing such operations, it seems that convenience can be enhanced while suppressing inconvenience for the user at first glance. However, such use has a pitfall. Specifically, in a case where the risk determination process of the user is habituated not to normally occur in the thought process in the brain, an adverse effect occurs. Each time a state requiring a certain determination instruction occurs, the autonomous driving system receives an autonomous instruction from the user. However, when repetition of uniform confirmation by the user becomes remarkable, this is no longer a selection instruction by the user after predicting a result which should originally occur. When falling into such a situation, the user starts to disregard prediction determination of the risks that the autonomous driving system cannot cope with while independently maintaining attention to the front. Therefore, depending on a situation, the vehicle 1 may become unable to continue traveling due to imperfect prediction or is forced to perform emergency deceleration or to stop, which may cause various macro social adverse effects such as a rear-end accident by a following vehicle or inducing a traffic jam. Therefore, in the present embodiment, in order not to cause excessive dependence by the user, it is desirable to refrain from use that is excessively dependent on the autonomous driving by excessive recommendations by the autonomous driving system or repetition of uniform confirmation of them.

The largest purpose of the use of the vehicle 1 by the user is not the use itself of the vehicle 1 having the autonomous driving system but an unerring arrival at the destination. As a result, by performing continuous situation recognition and grasping and performing optimal determination and instruction based on the situation recognition each time options are presented, early arrival at the destination is achieved. Meanwhile, if the user is forced to stay or stand by in an evacuation place unnecessarily since no appropriate selection is made with the option presentation, it is expected that the best option countermeasure is proactively made from the realistic viewpoint of a risk that inappropriate action selection by the user may delaying the arrival at the destination. In order to obtain social acceptability, as one of mobility means, for the vehicle 1 which is described in the present disclosure and can be used by a disabled person, the vehicle 1 utilizing an autonomous driving function incorporating intervention of the driver's selection intention, it is necessary to ensure that other traffic environment users are free from behavioral restrictions or danger. In the vehicle 1 used by a disabled person who cannot directly return to driving steering, even in a section corresponding to level 4, when the vehicle 1 passes the last option enabling evacuation, the situation will no longer allow the vehicle 1 to stop on a road side or the like in subsequent sections. Then, in such a case, if the vehicle enters a situation where the vehicle cannot travel in full automation as it is due to a change with time of the ODD or the like, the vehicle may be forced to stop or the like as it is in a traffic lane even if there is no evacuation place such as a road side. As an avoidance measure for reducing the occurrence of such an event, the best measure that can be taken by the autonomous driving system in design is to wait at a prior evacuation point until it becomes possible to reliably pass through the section unless the user selects the best measure suitable for the purpose. Since it is a pain to stand by without grasping the outlook of change in the situation, it is possible to confirm and determine the improvement measures from the standby state in order to achieve the initial goal of arrival at the destination; however, in this case, other avoidance measures will be overlooked. For example, if it is possible to make an early selection determination before arriving at the point, it is possible to request a temporary standby at a takeover point where the vehicle meets with a vehicle that can be a leading vehicle in advance or, for example, to go out from an exit of an expressway to a general road where low-speed traveling is allowed and pass through a section in a low-speed autonomous driving mode during use in which level 4 is allowed before the standby limit point. In a case of passing through a section by being guided by a leading vehicle used by an able-bodied person, it is desirable to exchange certain information such as confirmation of conditions of the led vehicle between the users of the leading vehicle and the led vehicle in advance. For example, it can be said that desirable operation is to perform certain prior communication such as a request for upper limit speed suppression, a request for passing with deceleration for suppressing centrifugal force at a corner, a curve, or the like, suppression of acceleration and deceleration due to load loading or boarding of an elderly person or a passenger with poor physical condition, or vehicle characteristics. It is also expected that, when electronically towing the vehicle 1 used by a disabled person, which is the led vehicle, the leading vehicle refrain from a mechanism of performing electronic traction only by coincidence of the point passaging timing without being able to perform a confirmation procedure such as exchange of the request content in advance. That is, it is necessary for the user who is the disabled person to issue an active leading work request and to provide information of electronic traction that the host vehicle needs. That is, the user who is a disabled person is required to grasp advance information of a traveling road at an early stage and simply wait, to issue an instruction without missing the timing of exiting to a general road, or to end the advance confirmation of leading guidance at an early stage with a leading vehicle candidate. This is because, in the use of the autonomous driving function by the disabled person, since the user himself/herself cannot perform the steering intervention in an equivalent manner to a regular able-bodied person, it is required to provide an early avoidance option before passing through the point at which the selection can be made. In addition, since the functional restriction of the disabled person has various states of the user, it is desirable that the display content of the advance notification point and the content of the assist request are managed by pre-reservation designation. By doing so, it becomes possible to avoid a general road that cannot be a countermeasure choice of the user, to prioritize selection places suitable for the user, and the like, which can enhance the convenience.

### <6.4 Functional Configuration>

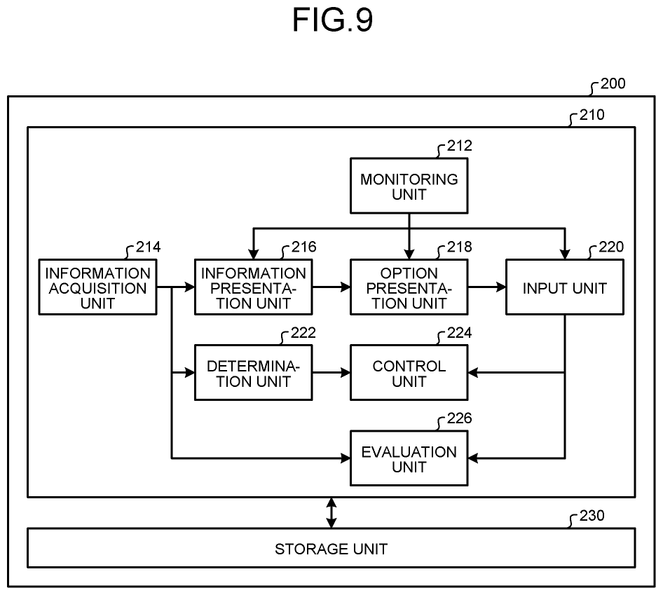

Next, the functional configuration of a block (information processing device) 200 of the main part of the vehicle control system 11 according to the embodiment of the present disclosure will be described in detail with reference to FIG. 9. FIG. 9 is a block diagram illustrating a configuration example of the main part of the vehicle control system 11 according to the embodiment. Note that illustrated in FIG. 9 is only functional units related to the present embodiment in the vehicle control system 11. Specifically, the block 200 corresponds to the travel assistance and autonomous driving control unit 29, the DMS 30, the HMI 31, and the vehicle control unit 32 illustrated in FIG. 4. As illustrated in FIG. 9, the block 200 mainly includes a processing unit 210 and a storage unit 230. Furthermore, the processing unit 210 mainly includes a monitoring unit 212, an information acquisition unit 214, an information presentation unit 216, an option presentation unit 218, an input unit 220, a determination unit 222, a control unit 224, and an evaluation unit 226. Hereinafter, details of each functional unit of the block 200 will be sequentially described.

### (Monitoring Unit 212)

The monitoring unit 212 corresponds to the DMS 30 in FIG. 4, monitors the state of the driver (passenger), and outputs a monitoring result to the information presentation unit 216, the option presentation unit 218, or the input unit 220 described later. In particular, in a case where the driver (user) is an able-bodied person, the information presentation unit 216, the option presentation unit 218, and others may select a presentation form depending on the state of the driver recognized by the monitoring unit 212.

### (Information Acquisition Unit 214)

The information acquisition unit 214 acquires various types of information for steering from the communication unit 22, the map information accumulating unit 23, the position information acquiring unit 24, the external recognition sensor 25, the in-vehicle sensor 26, and the vehicle sensor 27 in FIG. 4 and outputs the information to the information presentation unit 216, the option presentation unit 218, and the determination unit 222 described later.

### (Information Presentation Unit 216)

For example, in a case where a point, at which a section (first section) in which the full driving automation by the autonomous driving system is executed is switched to a section (second section) in which the autonomous driving is executed with intervention of the driver's determination according to the present embodiment, occurs due to a situation change of a route approaching portion, the information presentation unit 216 gives the driver advance presentation of various types of information acquired by the information acquisition unit 214 via the HMI 31 in FIG. 4 as early as possible. Note that the information presentation unit 216 may present the acquired information in an information form as it is, or the information may be analyzed by the analysis unit 61 in FIG. 4 and presented in an information form that is easy for the driver to understand without particular limitation. Furthermore, in the present embodiment, regarding the presentation form, it is possible to select virtual reality (VR) display, voice output, or various presentation forms depending on the degree of disability of the driver or the state of the driver recognized by the monitoring unit 212. Then, the driver makes determination on the basis of the information presented by the information presentation unit 216 and selects an option presented by the option presentation unit 218 described later. If this advance notification is not performed before a limit point where the input of the selection determination by the user can be received, the number of options available to the user decreases, and as a result, an inconvenient situation may occur. Therefore, a form of information presentation is important, such as that the user sets the number of options or setting to notify at timing with enough time with which an option to exit to a general road is always included in the options.

### (Option Presentation Unit 218)

The option presentation unit 218 presents, to the driver in advance, a plurality of options of steering contents in a section (second section) in which the autonomous driving is executed with intervention of the driver's determination according to the present embodiment. The option presentation unit 218 can change the content of the options depending on the degree of disability of a disabled person as the driver or depending on the state of the driver recognized by the monitoring unit 212 including able-bodied persons. Note that, in the present embodiment, options are presented to the driver via the HMI 31 of FIG. 4.

There are user who can perform a certain control instruction that can correctly and accurately perform an agile operation via a joystick or the like, whereas there are users who can use only an instruction form in which an input form of an instruction makes it difficult to accurately transmit the instruction to the autonomous driving system, such as a voice instruction, or to transmit including the emphasis on the instruction. In addition, for example, there are users who can only issue a selection determination instruction that takes time such as a numerical value instruction or left-right selection. In this manner, options that can be selected in the advancement of the travel plan vary greatly for each of users in various states. As a result, the time until a selection determination result is input to the autonomous driving system varies, and available options also vary depending on the situation of the physical ability of each user. Therefore, in this specification, since the present embodiment is not made exclusively for a specific physical function, description of details of an HMI and the display timing unique to various individual cases will be omitted.

### (Input Unit 220)

The input unit 220 corresponds the HMI 31 in FIG. 4 and receives, from the driver, the option selected by the driver's own determination. The input unit 220 can change the form of receiving the selected option depending on the degree of disability of the driver or the state of the driver recognized by the monitoring unit 212. For example, the input unit 220 can select any input form from among operation input using a steering wheel, a lever, a pedal, or a touch panel, voice input, line-of-sight detection input, gesture detection input, and biometric signal change detection input.

### (Determination Unit 222)

The determination unit 222 corresponds to the travel assistance and autonomous driving control unit 29 in FIG. 4 and makes determination regarding the steering content, early evacuation standby, detour selection, and the like on the basis of information output by the information acquisition unit 214 in the section (first section) in which full driving automation by the autonomous driving system is executed.

### (Control Unit 224)

The control unit 224 corresponds to the vehicle control unit 32 in FIG. 4 and performs steering control of the vehicle 1 on the basis of the option received by the above input unit 220 in a section (second section) in which the autonomous driving is executed with intervention of the driver's determination according to the present embodiment. In addition, the control unit 224 performs steering control of the vehicle 1 on the basis of the determination of the determination unit 222 described above in the section (first section) in which full driving automation by the autonomous driving system is executed.

### (Evaluation Unit 226)

The evaluation unit 226 corresponds to, for example, the DMS 30 in FIG. 4 and evaluates the selection result of the driver for the travel in the section (second section) in which the autonomous driving is executed with intervention of the driver's determination according to the present embodiment on the basis of the information (for example, the situation around the vehicle 1 and the like) from the information acquisition unit 214. For example, in the present embodiment, in a case where a predetermined state such as an emergency stop or occurrence of a traffic jam is realized in the section, points given to the driver in advance are deducted. Then, in the present embodiment, in a case where the points held by the driver becomes equal to or less than a predetermined score, the use of the autonomous driving is not permitted. Note that details of the evaluation and the like (provision of an incentive) in the present embodiment will be described later. In other words, in order to permit the user to continuously use the system according to the present embodiment subsequently without the points being reduced, the user is requested to continuously pay attention to the front and the like in order to avoid the vehicle 1 from falling into an emergency stop and the like as much as possible at the time of daily use, to grasp the risk, and to always make the best choice at an early stage.

### (Storage Unit 230)

The storage unit 230 corresponds to the storage unit 28 in FIG. 4 and stores the content of options presented by the option presentation unit 218 described above, a selection result of the driver received by the input unit 220 described above, an evaluation result of the driver by the evaluation unit 226 described above, and others.

Note that, in the present embodiment, the configuration of the block 200, which is a main part of the present embodiment, is not limited to the configuration illustrated in FIG. 9.

### <6.5 About Processing Method>

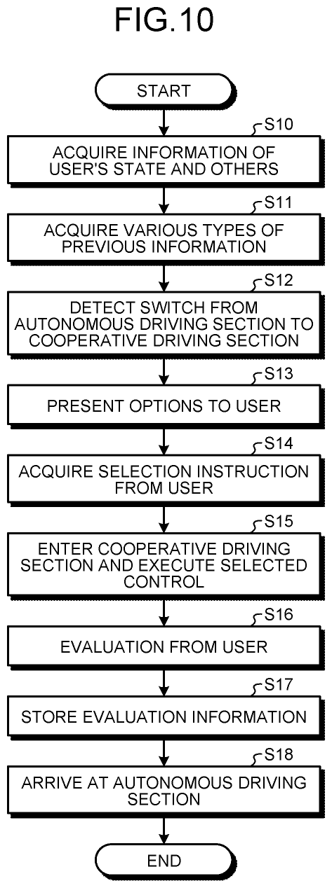

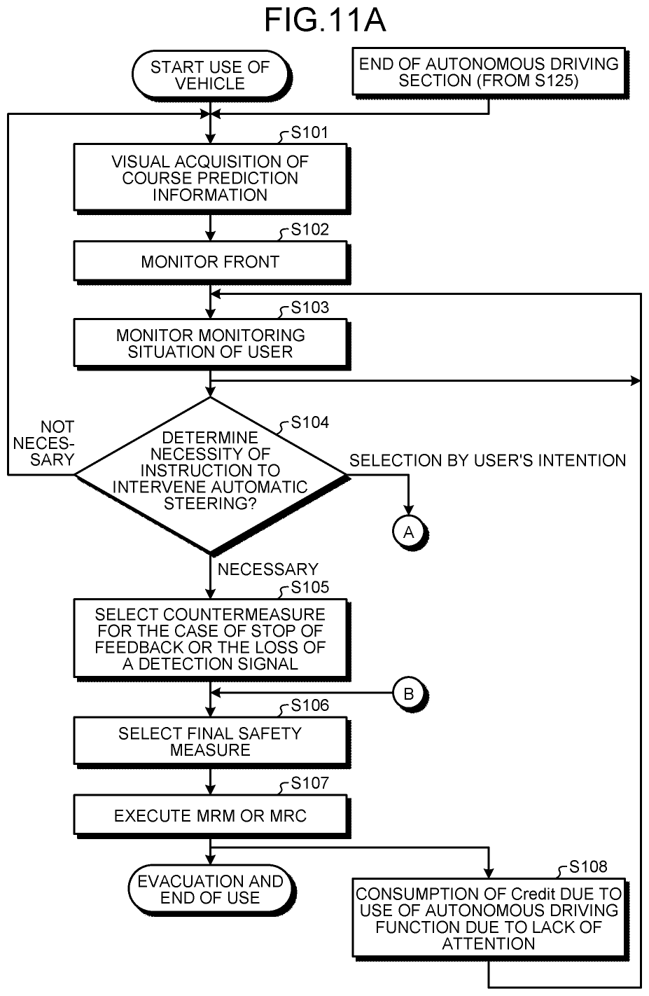

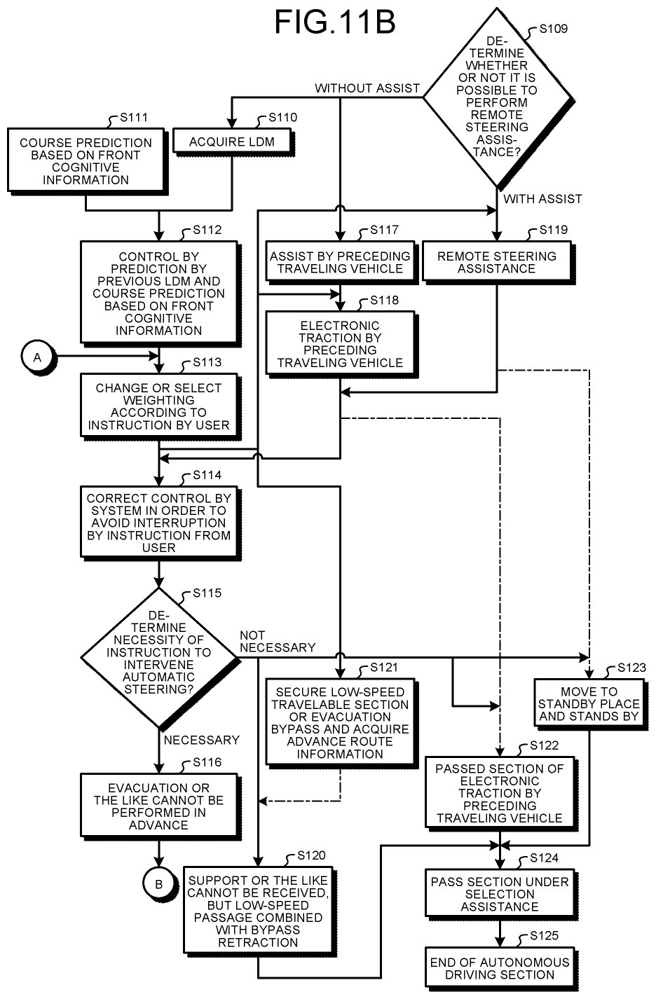

Next, an example of a processing method in the present embodiment will be described with reference to FIGS. 10, 11A, and 11B. FIGS. 10, 11A, and 11B are flowcharts illustrating an example of the processing method according to the present embodiment.

First, a basic flow of the processing method of the present embodiment will be described by referring to FIG. 10. Specifically, as illustrated in FIG. 10, the processing method according to the present embodiment can mainly include a plurality of steps from Step S10 to Step S18. Details of these steps according to the present embodiment will be described below.

Firstly, the autonomous driving system (the vehicle control system 11 illustrated in FIG. 4) acquires information regarding the state of a user and the like (for example, information such as levels of motor function or cognitive function) (Step S10). Based on these pieces of information, the autonomous driving system can select either traveling at the driving automation levels defined by the SAE or traveling at new driving automation levels according to the embodiment of the present disclosure. The autonomous driving system can also determine the timing of indicating the options to the user, the content of the options, and others on the basis of these pieces of information.

Next, the autonomous driving system acquires information regarding the destination or the like from the user or a preset schedule and controls the travel of the vehicle 1 in a section in which the autonomous driving is allowed while acquiring various types of previous information (for example, information such as traffic conditions, road conditions, and the weather) in the travel plan up to the destination (Step S11). Note that, in the following description, description is given on the premise that the vehicle 1 travels at the new driving automation levels according to the embodiment of the present disclosure. At this point, it is based on the premise that the user, who is a disabled person, monitors the front and others with attention.

Next, since various conditions (road conditions, incompleteness of mounted devices, insufficiency in acquired information, etc.) are not satisfied, the autonomous driving system detects that a section in which the autonomous driving is permitted will be switched in future to a section in which the user and the autonomous driving system have to cooperate for traveling, namely, a travel section at the new driving automation level according to the present embodiment (Step S12).

Then, the autonomous driving system presents, to the user, options selectable by the user in traveling at the new driving automation level at suitable timing (Step S13). The options presented at this point include, for example, a remote assist request by an operator, a request for electronic traction by a leading vehicle, and deceleration, evacuation, standby, and the like for performing these. Furthermore, for example, if steering in a low-speed travel section is possible depending on the physical ability of the user, avoidance travel to such a section may be performed. Furthermore, for example, an emergency stop may be performed while issuing a warning for attention to following vehicles.

Next, the user selects an appropriate option from the options presented in Step S13 described above in order to avoid a risk of entering a situation difficult to handle if the vehicle automatically travels as it is on the basis of information visually or audibly perceptually recognized by the user through monitoring the front or the like with attention. Then, the autonomous driving system acquires the selected instruction from the user (Step S14). Since an able-bodied person has a wide range of options of handling approach that can be adopted, it is not necessary to advance the notification. However, if the able-bodied person misses a selection point enabling evacuation and proceeds the route as it is, there is a possibility of entering a section where there is no road side stop nor an evacuation place. In a case where only measures such as an emergency stop can be taken due to the physical ability of the user to handle, it will be too late after passing through the point. Therefore, it is important for the user that the autonomous driving system presents an advance notification.

Then, at the timing of entering the section where the user and the autonomous driving system have to travel in cooperation, or immediately before that, the autonomous driving system executes the traveling control of the vehicle 1 in accordance with the instruction acquired in Step S14 described above (Step S15). Then, the vehicle enters the cooperative driving section, and Steps S13 to S15 are each described as an individual step; however, in a case where the necessity of intervention is repeated several times, the notification of Step S13 is made in advance each time, and appropriate control is urged.

Furthermore, the autonomous driving system evaluates the determination (selection of an option) based on the monitoring by the user on the basis of the subsequent traveling situation of the vehicle 1 (whether or not traffic congestion or the like has been caused, whether or not a situation has been caused which forces following vehicles to take emergency countermeasures for avoiding an accident, or the like) (Step S16). An incentive or the like is given to the user in accordance with this evaluation, and details thereof will be described later. Note that, although the present embodiment mainly presumes the use by a disabled person, since there is such evaluation or provision of an incentive, it is possible to encourage, even in a case of use by an able-bodied person, to independently select an appropriate option.

Next, the autonomous driving system stores information of the options indicated in Step S13 described above, information of the option selected in Step S14 described above, a subsequent traveling situation of the vehicle 1, and information of the user evaluation in Step S16 described above, and others (Step S17).

Then, when the vehicle 1 reaches an autonomous driving section, the autonomous driving system switches to the autonomous driving control and ends the processing according to the present embodiment (Step S18).

Next, a detailed flow of the processing method of the present embodiment will be described with reference to FIGS. 11A and 11B. Specifically, as illustrated in FIGS. 11A and 11B, the processing method according to the present embodiment can mainly include a plurality of steps from Step S101 to Step S125. Details of these steps according to the present embodiment will be described below.

First, as illustrated in FIG. 11A, the driver visually acquires information such as course prediction information presented by the autonomous driving system due to the end or the like of the autonomous driving section by the autonomous driving system (Step S101). Furthermore, the driver monitors the state of the front, the right, and the left sides of the vehicle 1 through the windshield or the side glasses (Step S102).

In addition, the autonomous driving system monitors the state of monitoring (attention to the front, etc.) of the driver as the user (Step S103).

Furthermore, the autonomous driving system determines the necessity of intervention by the determination of the user on the basis of a situation of fetching the course prediction information or the LDM information, the state of the sensors, or the like. At this point, the necessity of intervention may be determined by the user (Step S104). If the autonomous driving system determines that there is the necessity, the process proceeds to Step S105, and if the autonomous driving system determines that there is no necessity, the flow returns to Step S101. Furthermore, in a case where it is determined by the user that there is the necessity, the process proceeds to Step S113 in FIG. 11B.

The user selects the optimal countermeasure from among the countermeasure content for the case of stop of feedback or the loss of a detection signal presented from the autonomous driving system (Step S105). Furthermore, the autonomous driving system selects the final safety measure in accordance with the selection in Step S105 above (Step S106). Next, the autonomous driving system executes the MRM, the MRC, or the like and ends the use of the autonomous driving (Step S107).

Furthermore, in the present embodiment, the autonomous driving system also performs the processing of Step S108 in parallel for the evaluation of the state of the user (duty of attention monitoring) so far or the processing regarding whether the credit has been consumed associated with the evaluation (Step S108).

In addition, as illustrated in FIG. 11B, in a case where a request for remote steering assist by an operator is made by the autonomous driving system or the user, pairing with an operator is performed in a control center or the like, and whether or not the assist is possible is determined (Step S109). If no assist can be obtained, the process proceeds to Steps S110 and S117 (these steps are executed in parallel), and if the assist can be obtained, the process proceeds to Step S119.

The autonomous driving system acquires an LDM (Step S110). In parallel with Step S110, the autonomous driving system recognizes the situation ahead of the vehicle 1 or the like and performs course prediction on the basis of the cognitive information (Step S111). Furthermore, the autonomous driving system controls the vehicle 1 by prediction based on the LDM acquired in advance and the course prediction based on the front cognitive information (Step S112).

Furthermore, the autonomous driving system receives an instruction from the user and modifies and selects a weighting in an algorithm for the control of the vehicle 1 (Step S113). Here, depending on the modified algorithm, the process may proceed to Step S121, Step S118, or Step S119 described later. Then, the autonomous driving system corrects the algorithm for the control of the vehicle 1 in order to avoid the interruption of the traveling based on the instruction of the user in Step S113 described above (Step S114).

Next, the autonomous driving system determines the necessity of intervention by the determination of the user on the basis of a situation of fetching the course prediction information or the LDM information, the state of the sensors, or the like (Step S115). If it is determined that there is a need for intervention, the process proceeds to Step S116, and if it is determined that there is no need, the process proceeds to Step S120, S121, or S123 in accordance with an instruction of the user.

If the autonomous driving system determines that the vehicle 1 cannot be evacuated in advance (Step S116), the process returns to Step S106 illustrated in FIG. 11A.

The autonomous driving system requests assistance by a preceding traveling vehicle (Step S117). Then, the vehicle 1 is electronically towed by a leading vehicle (Step S118). Furthermore, the autonomous driving system returns to Step S114 described above. In addition, the process proceeds to Step S122, which is processing of a case where a section has been passed by the electronic traction.

The autonomous driving system requests the remote steering assistance by an operator (Step S119) and returns to Step S114 described above. Then, the vehicle 1 moves to a standby place to receive remote steering assistance and executes Step S123 for standing by.

The vehicle 1 cannot receive support such as the remote steering assistance but evacuates to a bypass section or the like that avoids a section where the autonomous driving cannot be used and travels at a low speed by steering or a steering selection direct instruction by the user (Step S120). In a case where control of the vehicle 1 by a disabled person is assumed, there are cases where agile steering control equivalent to that by an able-bodied person cannot be expected, and thus, for example, it is shifted to low-speed autonomous driving. In a case where it is difficult to pass only by the autonomous driving function provided by the system even at a low speed, for example, when the vehicle comes to the corresponding section, passage candidate planning of a portion that causes the system to block passage therethrough is presented to the user on a screen or the like, and if the planning has no risks, the user approves the planning as it is and passes through the section. In addition, for example, in a case where the system regards a protruding portion of plants from the periphery of a road as an obstacle, considers it as a risk, and hesitates to pass, whereas there is no need to consider it as an obstacle on the basis of visual determination by the user, the user may select to pass through as it is as long as there is no direct harm even if the user approves to pass while the vehicle is in contact with the protrusion, and alternatively, as a choice to avoid contact with the protrusion, for example, if a site is secured that is continuous with a road surface on which the vehicle can safely travel even if the vehicle deviates from the road section, a section passage instruction may be issued by inputting the determination of the user. In this manner, it is possible to perform various instructions if the speed is low.

The autonomous driving system secures a low-speed travelable section or an evacuation bypass or acquires route information in advance (Step S121).

The vehicle 1 travels and passes through the corresponding section by electronic traction by the preceding traveling vehicle (Step S122).

The vehicle 1 moves to a standby place to receive the remote steering assistance and stands by (Step S123).

The vehicle 1 passes through the corresponding section under the selected assistance (Step S124). Then, the autonomous driving section ends (Step S125).

Note that the flows illustrated in FIGS. 10, 11A, and 11B are merely examples, and the processing method according to the present embodiment is not limited thereto.

### <6.6 About Provision of Incentives>

Next, details of the incentive provision in the present embodiment mentioned above will be described.

As a premise for promoting the use of the autonomous driving by the disabled persons, it is necessary not to disturb the road traffic infrastructure which is a core of the social infrastructure. Therefore, in the present embodiment, in a case where traveling cannot be continued since the autonomous driving system has to give up on traveling due to insufficient determination, with the user complementing and intervening in the determination, it becomes possible to pass through the corresponding section without interrupting traveling, which can prevent escalation to traffic obstruction.

Examples of a case where the determination by the autonomous driving system cannot be made immediately include, as described prior, the determination in consideration of a medium- to long-term influence. Therefore, in the present embodiment, the user complements this determination and gives an instruction based on the determination. However, in order for such use of autonomous driving to be socially accepted, it is premised that necessary information is given to the user in an appropriate form, and appropriate determination and instruction can be made. Therefore, an HMI that enables appropriate provision of advance information is required, including a measure against occurrence of a situation in which the LDM or the like cannot be obtained in advance, such as insufficient information regarding the traveling scheduled section. Note that, in a case where autonomous driving is used as a means of travel in an area where data that is constantly updated, such as the LDM, cannot be obtained, it is required that there be a situation in which electronic traction can be performed by a leading vehicle. In addition, at this point, a remote steering assistance by an operator is also an option; however, since these may not be always available, it is important that the user grasps the situation in advance via the HMI.

In addition, when the disabled person uses the autonomous driving, it is required to appropriately understand the mechanism, the system, and others of the autonomous driving and to always make an appropriate choice, and such an appropriate choice can avoid hindering other traffic users. For the appropriate determination and selection, a mechanism is required for intuitively providing, in an easy-to-understand manner, information that forms a basis of the determination by the user. Note that, in the present embodiment, an important element of the HMI is to provide information of risks that can arise as a result of selection or information to facilitate determination of the risks, and the user can make more appropriate determination by examining the degree of each risk that is provided. In addition, although it is important to provide detailed information of the route, it is even more important that the HMI can provide an avoidance measure for avoiding a risk that can arise in a case where the information cannot be acquired. This is because if the determination of an appropriate avoidance measure is disregarded due to lack of information, the vehicle 1 may be stuck or may become unable to move during traveling, which also leads to disturbance of the road traffic infrastructure. One of prospective means is visual map display; however, in the present embodiment, it is not necessarily limited to display (visual information presentation). Furthermore, in the present embodiment, since the degree of freedom of hands, legs, and others of a disabled person may be limited unlike an able-bodied person, verbal communication using voice recognition or the like, gesture control, or others may be used as one of input means.

In addition, it is conceivable that it is difficult to appropriately perform the operation only by requesting the user to make an appropriate choice. For example, execution of an emergency stop or the like by the autonomous driving system frequently occurs due to reasons such as that some users cannot take physical measures or make a determination instruction appropriately, that is, inappropriate operation is performed. In such a case, use of the autonomous driving by a disabled person may not be socially accepted.

Therefore, in the present embodiment, it is preferable to provide a mechanism for giving an incentive to the user in order to prompt appropriate determination and selection.

Specifically, in the present embodiment, a credit, having a predetermined score for permitting travel using the autonomous driving function, is given to the user in advance, and when the user neglects or disregards the surrounding monitoring duty for avoiding the traveling risk, the score of the credit held by the user is reduced. In a case where the score of the credit the user has becomes equal to or less than a predetermined score, the incentive to permit the use of the autonomous driving function of the user is eliminated. If the user with a low credit score continues to travel with the vehicle 1 with the assistance of the autonomous driving system, there is a high probability that the user will fail to take necessary measures, and the user will rely on an emergency stop, sudden deceleration and evacuation to a road side, and the like during traveling, which causes secondary problems such as a rear-end accident by the following vehicle, forcing following vehicles to take an unreasonable evacuation in a section with poor visibility, or obstruction of passage. Therefore, since such behavior is difficult to be socially accepted, it is difficult to allow the use of the autonomous driving by the user in the system. That is, in the present embodiment, in a case where the credit carried is equal to or greater than the predetermined score, the right to continuously use the autonomous driving function is maintained; however, when the credit drops equal to or less than the predetermined score, the right disappears.

Since the user can use the autonomous driving function by holding the credit equal to or higher than the predetermined score, a great advantage of securing a means of travel can be obtained. Meanwhile, in the present embodiment, with the credit held by the user being equal to or less than the predetermined score, it is determined that there is a high possibility that the duty cannot be fulfilled, namely, the user is unreliable. Then, since the reliability cannot be immediately restored, the user becomes unable to use the autonomous driving function, thereby losing the great advantage of securing the means of travel. Therefore, adopting such a mechanism has a great effect of preventing neglect of the monitoring duty from the viewpoint of behavioral psychology.

### <6.7 Instruction Input>

Next, instruction input from a user to the autonomous driving system in the present embodiment will be described.

There are cases where a user has disability in limbs and cannot freely control devices such as the steering wheel, the brake, and the accelerator that an able-bodied person uses for steering. It is also conceivable that it is necessary to prepare various devices as the instruction input device that the user can use depending on the disability state of the user. For example, in the present embodiment, the followings are used:
1. Joystick-like lever operable with one hand (steering instruction to forward, rearward, leftward, or rightward, instruction confirmation by pushing, etc.;
2. Device capable of giving an instruction on front, rear, left, right, up, and down steering by movement of a foot in a similar manner to the joystick;
3. Touch panel (operate with a finger or a palm);
4. Tactile sensor or the like capable of giving a steering instruction at a body part such as an elbow or a jaw;
5. Device that directly captures a change in an electric signal from a muscle or the brain of the user and converts the change into an instruction input signal;
6. Device that captures an instruction by a change in the line of sight of a user, or a verbal communication device that recognizes voice from the voice of the user and extracts an instruction;
7. Gesture recognition device; and
8. Device that visually displays and feeds back an instruction by a signal captured by the above devices to a user and enables confirmation of the instruction content and adjustment of the amount of the instruction.

Note that, depending on future development of the technology, a new instruction input means may be applied such as a device that directly observes a nerve transmission signal and issues an instruction or control to read a surface layer detection signal via the skin or to directly read a signal from the brain, and the present embodiment is not necessarily limited to the above example.

Note that the user's complementary intervention in the steering can be roughly divided into two use cases. The first one is an approval type. The approval type is control in a form in which the user approves traveling of the vehicle 1, and the control is performed by an advance-approval-type operation as a premise for the vehicle 1 to travel forward. For example, the user approves the forward traveling instruction by tilting the lever forward, and the vehicle stops when the hand is released from the lever. In addition, for example, the forward traveling control is performed by the amount how much the accelerator pedal is depressed, and the forward traveling control of the vehicle is performed by constantly inputting for confirmation that the user always travels forward in such a manner that the vehicle decelerates when the depression amount is reduced and stops when no depression is detected.

The second one is a steering control intervention type. The steering control intervention type is a use form of a type that intervenes in the determination only when proactive intervention by the user is necessary, and in a case where there is no particular instruction, the autonomous driving system controls the traveling. The latter use is convenient in that it does not cause much trouble to the user; however, in a case where there is a performance limit in the future prediction for the traveling of the autonomous driving system, the vehicle may travel with insufficient future predictability in some cases, which may lead to a dead end state in which recovery is difficult and to a situation in which the host vehicle or other vehicles are exposed danger. Therefore, in order for such a form as the latter to be accepted socially, it is required for the user to take a responsible early countermeasure even in a situation where the autonomous driving system cannot make a prediction alone. Therefore, what is important in terms of system design is a mechanism that enables the user to intervene in a timely manner, and it is important to construct a mechanism that does not cause a delay in handling via the HMI as with an able-bodied person.

In addition, in order for the user to proactively perform a timely countermeasure without delay on the basis of the information acquired through the HMI, it is necessary to motivate the user, and it cannot be expected that the user takes an action of prediction avoidance from “nothing” with no information. Therefore, the information provided to the user is required to incorporate a device that is different from the information provision for the able-bodied persons who handles in the normal manual driving.

In addition, since the content that need to be preferentially handled by the user varies depending on the way of intervention by the user, in the present embodiment, it is preferable that display content to be given to the user by display or the like via the HMI are parameterized and that display or notification to be given to the user is sorted out and given at appropriate timing by referring to the parameters depending on the way of intervention, the situation of the user, or others. Furthermore, for example, it is preferable that a vehicle dealer or the like sets a display pattern, timing, and others in advance depending on the disability of the user and delivers the vehicle so that the display or the like can be performed depending on the user.

Specifically, for example, as the display during traveling to be presented to the user in a case where the user does not intervene at all, when entry into a section requiring the user's intervention is predicted, it is conceivable to display a detour or a point where standby is possible in advance before the entry into the section. On the other hand, in a case where the user can input a control instruction through the steering wheel or the like, the intervention can be performed directly and promptly, and thus, it is not necessary to consider avoidance to a detour or the like in advance. Therefore, as the HMI, the timing at which intervention (driver's steering) is necessary is notified in an equivalent manner to that of an able-bodied person or, in a case where it is not as good as a response of the able-bodied person, immediately before within a range where a necessary offset is considered. In addition, unlike a situation where the able-bodied person completely performs a secondary task during autonomous driving, in the use by a disabled person, it is expected that an appropriate countermeasure is performed in a shorter period of time due to the necessity of monitoring by the user.

### <6.8 HMI Focused on Display>

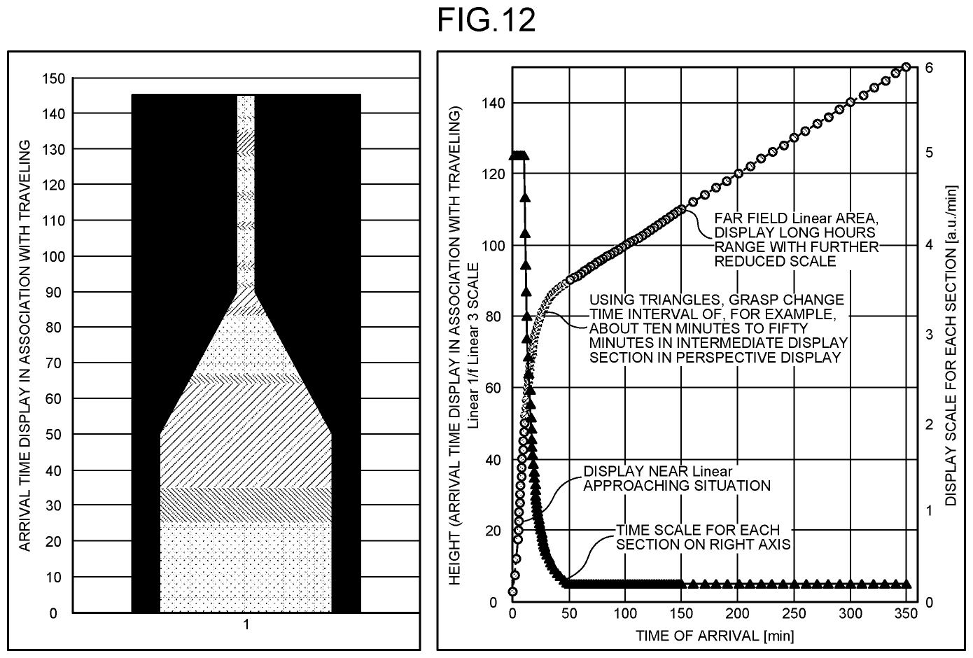

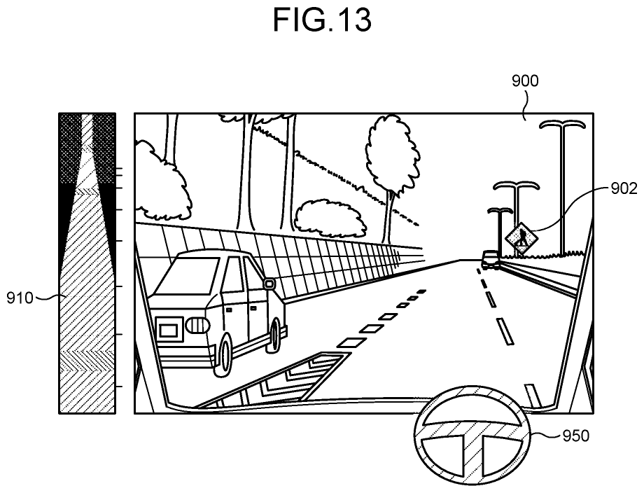

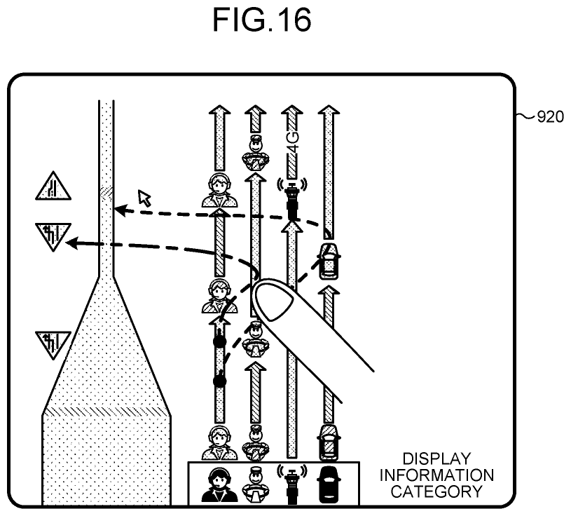

In a case where the user has functions necessary for the vehicle control intelligently and physically and can appropriately make determination or input regarding the vehicle control, an HMI corresponding to the user is included in the present embodiment. Herein, an HMI that provides information and the like to the user mainly by display will be described with reference to FIGS. 12 to 16. FIG. 12 is an explanatory diagram for describing an example of display by an HMI according to a comparative example, and FIGS. 13 to 15 are explanatory diagrams for describing an example of display by the HMI according to the present embodiment. Note that FIG. 16 is an explanatory diagram for explaining an example of input by the HMI according to the present embodiment. In the present embodiment, for example, the content of a risk that makes it difficult to safely pass through a section and a point where the risk arises are displayed corresponding to the travel of the vehicle 1 using the HMI. In the present embodiment, by using such display, the user is urged to intervene the determination before passing through a point where the determination and selection can be made when approaching the section.

In the HMI used by the able-bodied persons, information is provided as information for the user to take over the driving steering from the autonomous driving system by predicting the end timing of the ODD depending on the situation of the vehicle 1 or the road situation while performing other work other than driving so that the user can regularly grasp a short-term prediction, a mid-term prediction, and a long-term prediction. For example, as illustrated on the left side in FIG. 12, with the current position of the host vehicle being as the starting point, a band indicating the state of the road or the like on which the host vehicle will travel from now is displayed upward. The band has a shape in which the width becomes narrower from the current position of the host vehicle on the lower side to the upper side depending on the height on the screen. With such band display, in FIG. 12, the position in the vertical direction indicates the traveling time. Moreover, by changing the display magnification of each section, an example is illustrated as an example of a display scale on the right side of FIG. 12 which includes display with an enlarged time axis for the arrival in the short term, display of intermediate sections in accordance with the perspective interval which is the reciprocal of time, and, for the far filed with distance equal to or more than a certain distance, display with reduction corresponding to the perspective scale thereof.

Furthermore, each section of the band is classified by a pattern or a color, and the state (such as a section in which the autonomous driving at the driving automation level 4 is possible, a section immediately before returning from the autonomous driving to manual driving, or a section in which the manual driving by the driver is essential) of a section is indicated by the pattern or the color. With such display, the driver can easily grasp the timing to return from the autonomous driving to manual driving in a short to medium term.

Meanwhile, in a case where use by a disabled person is assumed, there is a problem that it is not possible to promptly handle manual driving when traveling by the autonomous driving system is interrupted. Therefore, it is important to avoid falling into a situation where it is forced to give up traveling, and for this purpose, it is important to appropriately provide information for making the best selection determination. As illustrated in FIG. 12, providing options on a short- to medium-term time axis is also important for accurately grasping a situation in which a point requiring selection determination is approaching. In particular, since development of fully autonomous driving technology is expected to advance. Therefore, if only the first scale is displayed or widely-used perspective display corresponding to the front view is used, sections that can be displayed are limited, and it is difficult to intuitively provide information of the influence of a determination result of the user. That is, since the user cannot make an appropriate selection determination at an early stage, the user may unnecessarily evacuate or, conversely, by not selecting an avoidance detour in expectation of later evacuation or assistance, if it is determined as a result that the autonomous driving system cannot safely continue traveling in a section without even a road side or the like, the vehicle may make an emergency stop on a lane even without evacuating from the road.

More specifically, in a case where there is a section in which a shortage of information used for determination for passing by autonomous driving is expected, the HMI based on the premise of use by a disabled person provides the user with information of the presence of such a section in a form of calling attention. In addition, in a case where it is possible to continue traveling by the user making a determination and an instruction, namely, by making a detour to a general road or a road aside a main road on which traveling by autonomous driving is possible if at a low speed even if it is difficult to perform autonomous driving at a high cruising speed, requesting electronic traction by a leading vehicle, or requesting remote steering assistance by an operator, the HMI can present these options to the user.

As the HMI that generally presents information to the user without specifying the content of a specific physical disability, an HMI that can provide visual information as illustrated in FIG. 13, namely, information by display is conceivable. In an HMI illustrated in FIG. 13, information of a road or a preceding vehicle that can be visually acquired by the user through the windshield of the vehicle 1 is provided as an HMI 900 for forward information as major information in association with traveling. That is, this is similar to the conventional case where an able-bodied person uses the vehicle 1. Furthermore, in the present embodiment, the user basically recognizes surrounding environmental information by visually recognizing the front and recognizes other information (planned course information and the like) by an HMI (specifically, a display) 910 located not in the front but in a direction deviated from the field of view. Note that, although a steering wheel 950 is illustrated in FIG. 13 to clearly indicate the driver's seat, the steering wheel 950 may not be included in the present embodiment.

In the present embodiment, in a case where information necessary for traveling is provided to the user, it is not preferable to display a navigation screen or a center console panel in front of the user in such a manner as to obstruct the line of sight from being directed in the traveling direction. Specifically, in a case where the user places the line of sight on the above-described screen or the like for a certain period of time, the attention is diverted from the front of the vehicle 1, which may lead to overlooking a dangerous situation that can suddenly approach the vehicle 1. Therefore, in the present embodiment, it is preferable that the HMIs 900 and 910 are configured in such a manner as not to significantly interfere with the user's front field of view in the traveling direction and to accurately provide the information in a case where the necessity is high.

A head-up display (HUD) can be mentioned as one of the forms suitable for such a purpose. Specifically, this is an HUD capable of performing three-dimensional augmented reality (AR) display 902 by superimposing information over a real space through the windshield. Note that the AR display is preferably displayed at a convergence point of the reciprocal display section with respect to an approach time axis, namely, at a point where the height corresponding to the infinite-point coincides with the horizontal line when viewed from the viewpoint of the user. In this manner, by matching with the infinite horizontal line, it is possible to match with the sensation of the approach time of the user during constant speed traveling. However, in a case where information is provided in the front of the driver's field of view in the disclosure form illustrated in FIG. 12, since the vertical position in the field of view of the user is displayed in a scale different from that of the geometric arrival time associated with the traveling, it is desirable to display by clarifying the distinguishability from the front field of view, and, in order to prevent erroneous recognition of the arrival time interval, it is desirable to include a devise such as displaying arrival reference lines five minutes or ten minutes ahead together with and in conformity with the display screen.

Furthermore, in the present embodiment, in order to minimize interference with a line of sight directed ahead of the vehicle 1 through the windshield as much as possible, as the AR display 902, marker display on both sides of a traveling lane, marker display imitating, for example, a guardrail outside the vehicle width of the host vehicle, marker display indicating a point requiring attention, a section represented by a coarse pattern that allows the background to be visually recognized, or the like is used. More specifically, the information leading to a risk of stop of traveling is displayed in a coarse pattern or in a semitransparent manner in which the field of view of the user is not completely shielded while ensuring that the viewing angle diameter ϕ of the user with respect to the real space is maintained at equal to or greater than 0.5 degrees, for example. In order to call for attention while accurately grasping the background situation, it is also possible to further enhance the effect by combining with an eye-catching dynamic pattern.

In addition, as illustrated in FIG. 13, the HMI 910 that performs auxiliary display such as “planned course information” is preferably installed near the passenger seat having a low risk of interfering with the field of view. In the present embodiment, the display of the “planned course information” may be temporarily turned off at the time of turning right or left at an intersection or the like in order to minimize interference with the attention for confirmation directed to the front, the right, or the left. In addition, the auxiliary display may be turned off by the user's selection, or the display may be automatically turned off at the timing when the vehicle 1 reaches a point where a right or left turn is expected other than a straight lane. Such approaches are made since there are cases where the display illustrated in FIG. 13 is not suitable in a case where it is necessary for a disabled person to continue traveling while simultaneously acquiring information that affects in the medium- to long-term while securing the vision without failing to pay attention to the front or, for example, a case where a vehicle approaches a crossroad or the like and it is necessary to grasp the situation on the left and the right with good visibility in order to turn right or left.

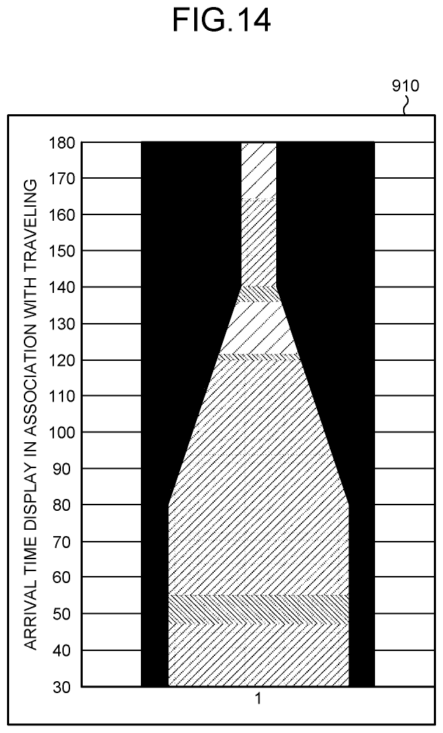

Furthermore, in the present embodiment, as illustrated in FIG. 14, the HMI 910 for displaying the “planned course information” may be similar to the display for the able-bodied persons. For example, as illustrated in FIG. 14, with the current position of the host vehicle being as the starting point, a band indicating the state of the road or the like on which the host vehicle will travel from now is displayed upward. The band has a shape in which the width becomes narrower from the current position of the host vehicle on the lower side to the upper side depending on the height on the screen. With such band display, also in FIG. 14, the position in the vertical direction indicates the traveling time. Each section of the band is classified by a pattern or a color, and the state (such as a section in which the autonomous driving by the autonomous driving system is possible or a section in which intervention by determination of the user is necessary) of the section is indicated by the pattern or the color. With such display, the user can grasp the timing at which the user makes determination and an instruction in advance.

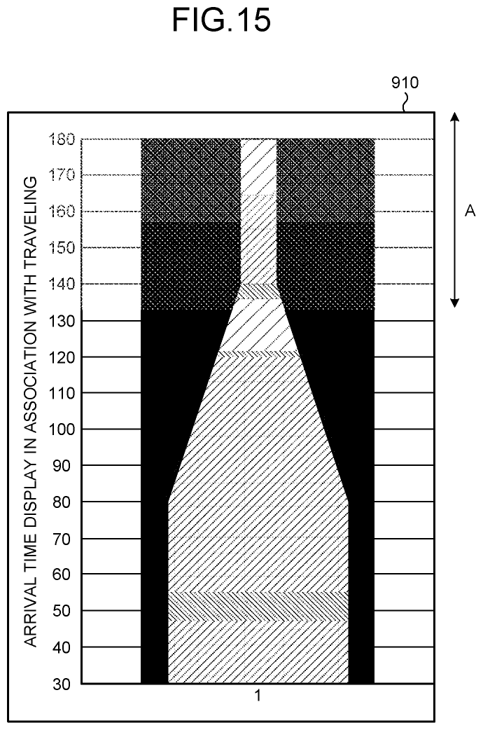

Furthermore, in the present embodiment, as illustrated in FIG. 15, sections (area indicated by A in the figure) indicating future states rather than the immediate state in the “planned course information” may be displayed in a blurred manner like the vision via frosted glass so as not to disturb the determination by the user.

Alternatively, in the present embodiment, for example, as an example of displaying information on a control terminal that can be directly steered by the user and giving a direct instruction on the terminal screen with a finger or the like instead of depicting on a window by the HUD or the like, the options may be displayed as illustrated in FIG. 16 by an HMI 920 (specifically, a display). In this display example, specifically, options such as remote assistance by an operator and electronic traction by a preceding vehicle are displayed by illustration or the like that is easily visually recognized, and the user can input an option by operating a touch panel installed by being superimposed on the display.

Note that, in the present embodiment, the HMI is not limited to the forms illustrated in FIGS. 13 to 16.

### <6.9 HMI Focused on Voice Recognition>

Next, a description will be given to a case where the user has the ability of determination, utterance, hearing, visual acuity, or the like equivalent to those of an able-bodied person and inputs a determination result to the autonomous driving system by voice input.

In such a case, as a situation in which the autonomous driving system can recognize an instruction by the voice input and can lead to the actual control of the vehicle 1, it is based on the premise that the instruction content is limited to simple instructions such as stop, turn left, turn right, and the like. Although it takes time to extract the instruction content from the voice, it is technically possible. However, from the viewpoint of reliability and robustness of recognition, namely, in order to avoid the risk of erroneous recognition, the instruction content is limited to simple instructions. Moreover, since the instruction content is simple, the autonomous driving system needs to grasp depending on what type of situation the user issues the instruction. As an example in which the voice instruction is most effective, there is conceived a case where, in a section where the low-speed autonomous driving mode can be used, it is difficult for the autonomous driving system to pass unless a holding additional instruction is obtained. In order to transmit the content by a voice instruction, there are cases where accuracy is insufficient at a technical level of today. However, in the case of low-speed operation, it is also possible to perform such control that the autonomous driving system visualizes the voice instruction for confirmation, for example, the traveling control is illustrated in a bird's-eye view to prompt the user to confirm, and that the instruction is reflected to dynamic steering control only after the user finalizes the interpretation.

### <6.10 Use Cases>

In a case where the user has a leg disability and is capable of moving the upper body only, it is sufficient to introduce a steering device which enables operation of an accelerator, a brake, a steering wheel, or others only by an upper arm, and steering can be performed without using the autonomous driving according to the present embodiment. However, by using the autonomous driving according to the present embodiment, it is possible to improve the safety and to reduce the burden at the time of steering.

In addition, even in a case where the user has an optic nerve disease and is unable to ensure the agility of the motion of the foot such as accurately depressing the brake, it is possible to instruct braking of the vehicle without depending on the limited physical function of the foot. Therefore, it is also possible to increase the safety or to reduce the burden at the time of steering by using the autonomous driving according to the present embodiment.

In addition, in a case where the user has peripheral environment perception ability equivalent to that of an able-bodied person but has a limited degree of freedom of the fingertip and is capable of performing instruction input necessary for control of the vehicle 1 with a certain level of agility and accuracy by using extremely limited physical functions of a hand, an arm, a leg, the jaw, the head, or others, in the present embodiment, the instruction input of the user is not for the steering itself but mainly for instructions of standby, deceleration, detour, or the like for avoiding sudden stop or the like in autonomous traveling by the autonomous driving system.

In addition, even in a case where the user has a disability in the peripheral perceptual ability of the eyes, color blindness such as inability to distinguish colors of traffic lights, or the like, it is possible to secure a means of travel similar to the use by an able-bodied person by cooperating with the autonomous driving system, namely, by the user making determination in a complementary manner. In addition, for example, in a case where a user, having a disease with which the visual acuity decreases in a part of the peripheral visual field such as age-related macular degeneration and having a weaker peripheral visual field, has partial physical disorder such as that the risk recognition is delayed due to overlooking of an approaching vehicle from the surroundings such as a pedestrian or at a merging point, the system supplementarily performs display of eye-catching information or the like that calls for attention to a risk detected by the autonomous driving system by an attention calling lamp or the like installed in a direction arrangement on an eyeball side where the visual acuity of the user is not decreased. In this case, for example, traveling can be continued by, when the autonomous driving system detects information that can pose a risk, simply displaying the risk in a form that is easily visually recognized in a field of view or the like in which the user's perception ability is effective and with the user making determination and an instruction on the basis of the information. Furthermore, in the present embodiment, in an area where the attention of the user is likely to be lowered, the autonomous driving system may intensively perform early warning assist, emergency braking handling, and the like. That is, it is also possible to intervene the autonomous control of braking or collision avoidance in which priority weighting is increased for a relatively approaching obstacle from a specific direction depending on the physical handling ability of the user.

As described above, the present embodiment can be used by disabled persons having various disabilities. Moreover, the control mode is implemented only by performing the new use form that is not classified into the conventional driving automation level 3 nor 4 of defined by the SAE.

### 7. SUMMARY

As described above, according to the embodiment of the present disclosure, it is possible to enable the disabled persons to use the autonomous driving technology, and at the same time, it is possible to minimize the risks that the autonomous driving causes congestion, a rear-end accident, or the like through such use while implementing a symbiotic society by facilitating participation of the disabled users to the society.

Note that, although an automobile has been described as an example in the embodiment of the present disclosure; however, the present embodiment is not limited to application to an automobile and can be applied to a traveling body such as an automobile, an electric car, a hybrid electric car, a motorcycle, a personal mobility, an aircraft, a ship, a construction machine, and an agricultural machine (tractor). That is, the embodiment of the present disclosure can also be applied to remote steering operations of various traveling bodies and the like.

### 8. HARDWARE CONFIGURATION

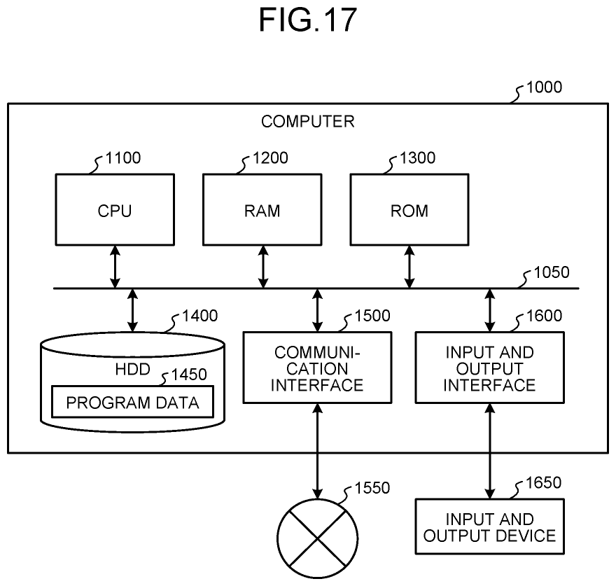

The whole or a part (in particular, the block 200 of FIG. 9) of the vehicle control system 11 such as the travel assistance and autonomous driving control unit 29 according to the embodiment of the present disclosure described above is implemented by a computer 1000 having a configuration as illustrated in FIG. 17, for example. FIG. 17 is a hardware configuration diagram illustrating an example of the computer 1000 that implements at least some of the functions of the block 200 in FIG. 9. The computer 1000 includes a CPU 1100, a RAM 1200, a read only memory (ROM) 1300, a hard disc drive (HDD) 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records an information processing program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from the input and output device 1650 such as a keyboard, a mouse, and a microphone via the input and output interface 1600. In addition, the CPU 1100 transmits data to an output device such as a display, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical (MO) disk, a tape medium, a magnetic recording medium, or a semiconductor memory.

For example, in a case where the computer 1000 functions as at least a part of the vehicle control system 11 according to the embodiment of the present disclosure, the CPU 1100 of the computer 1000 implements the functions of the travel assistance and autonomous driving control unit 29 or other units by executing a program stored in the RAM 1200. In addition, the HDD 1400 stores the information processing program and the like according to the present disclosure. Note that although the CPU 1100 reads the program data 1450 from the HDD 1400 and executes the program data 1450, as another example, these programs may be acquired from another device via the external network 1550.

Furthermore, the block 200 and others according to the present embodiment may be applied to a system including a plurality of devices based on a premise of connection to a network (or communication between devices), such as cloud computing. That is, the block 200 according to the present embodiment described above can be implemented, for example, as the information processing system according to the present embodiment by a plurality of devices. An example of the hardware configuration of at least a part of the vehicle control system 11 has been described above. Each of the above components may be configured using a general-purpose member or may be configured by hardware specialized in the function of each component. Such a configuration can be modified as appropriate depending on the technical level at the time of implementation.

### 9. SUPPLEMENTS

Note that the embodiments of the present disclosure described above can include, for example, an information processing method executed by the information processing device or the information processing system as described above, a program for causing the information processing device to function, and a non-transitory physical medium in which the program is recorded. Alternatively, the program may be distributed via a communication line (including wireless communication) such as the Internet.

Moreover, each of the steps in the information processing method according to the embodiment of the present disclosure described above may not necessarily be processed in the described order. For example, each of the steps may be processed in an order modified as appropriate. In addition, each of the steps may be partially processed in parallel or separately processed instead of being processed in time series. Furthermore, the processing of each of the steps may not necessarily be performed in accordance with the described method and may be performed, for example, by another method by another functional unit.

In addition, the examples described herein list cases based on the premise that an instruction is input to the autonomous driving system by utilizing existing and established technology; however, the input form of the user is not necessarily limited to the existing technology, and various input forms can be used as the instruction means such as more advanced voice recognition, use of utterance of sound and making a selective instruction only by the scale of the sound, an instruction only by opening and closing of the chin without uttering sound, or approval of forward and backward traveling by whether the upper body is in a forward tilting posture or in a backrest-leaned state. The point where the embodiment of the present disclosure is greatly different from the concept of the conventional autonomous driving use is not the form in which the fully autonomous driving at level 4 is continuously used nor handing over the entire control to the user side since continuous use at level 4 cannot be made, but that it is possible to provide mobility services to a disabled person who is uncapable of being involved in the overall steering control in such a manner as to utilize the autonomous driving by instruction-coordinated control by the user by appropriately providing the determination selection information in advance to the user while the system continuously performs the short-term emergency steering control and the planned control by an advance instruction.

The present embodiment is also technology that can provide improved accessibility to many people without being limited to the use of disabled persons if a mechanism for correctly performing the intervention in the control determination is established.

Although the preferred embodiments of the disclosure have been described in detail by referring to the accompanying drawings, the technical scope of the disclosure is not limited to such examples. It is obvious that a person having ordinary knowledge in the technical field of the present disclosure can conceive various modifications or variations within the scope of the technical idea described in the claims, and it is naturally understood that these also belong to the technical scope of the present disclosure.

Incidentally, the effects described in the present specification are merely illustrative or exemplary and are not limiting. That is, the technology according to the present disclosure can achieve other effects that are obvious to those skilled in the art from the description of the present specification together with or in place of the above effects.

Note that the present technology can also have the following configurations.
(1) An information processing device for performing automatic steering of a traveling body, the information processing device comprising:
   an option presentation unit that presents a plurality of options of steering content in a second section
   when the traveling body moves from a first section in which automatic steering based on determination by the information processing device is allowed to the second section in which automatic steering based on determination by the information processing device is not allowed;
   an input unit that receives, from a passenger of the traveling body, input of the option selected by the passenger's own determination; and
   a control unit that performs steering control of the traveling body on a basis of the option that has been received.
(2) The information processing device according to (1), further comprising:
   an information acquisition unit that acquires information for steering; and
   an information presentation unit that provides the information to the passenger,
   wherein, when the traveling body moves from the first section to the second section,
   the information presentation unit presents the information to the passenger.
(3) The information processing device according to (2), further comprising:
   a determination unit that determines steering content on a basis of the information,
   wherein, in the first section, the control unit performs steering control of the traveling body on a basis of determination by the determination unit.
(4) The information processing device according to (2) or (3), wherein the information presentation unit presents the information by VR display.
(5) The information processing device according to any one of (1) to (4), wherein the plurality of options includes at least one of an emergency stop, an electronic traction request, a remote steering assistance request, or low-speed autonomous driving.
(6) The information processing device according to any one of (1) to (5), further comprising:
   a monitoring unit that monitors a state of the passenger,
   wherein the option presentation unit changes content of the options depending on the state of the passenger.
(7) The information processing device according to any one of (1) to (6), wherein the option presentation unit changes content of the options depending on a degree of disability of the passenger.
(8) The information processing device according to any one of (1) to (7), wherein the input unit changes a form of receiving the option that has been selected depending on a degree of disability of the passenger.
(9) The information processing device according to (8), wherein the input unit selects any one input form from among operation input, voice input, line-of-sight detection input, gesture detection input, and biometric signal change detection input.
(10) The information processing device according to (9), wherein the operation input is input via a steering wheel, a lever, a pedal, or a touch panel.
(11) The information processing device according to any one of (1) to (10), further comprising an evaluation unit that evaluates a selection result of the passenger depending on a traveling situation of the traveling body in the second section.
(12) The information processing device according to (11), wherein the evaluation unit reduces points held by the passenger in a case where the traveling body enters a predetermined situation in the second section.
(13) The information processing device according to (12), wherein the evaluation unit does not allow use of the traveling body in a case where the points held by the passenger is equal to or less than a predetermined number of points.
(14) The information processing device according to any one of (11) to (13), further comprising:
   a storage unit that stores the plurality of options and the selection result of the passenger.
(15) An information processing system for performing automatic steering of a traveling body, the information processing system comprising:
   an option presentation unit that presents a plurality of options of steering content in a second section
   when the traveling body moves from a first section in which automatic steering based on determination by the information processing system is allowed to the second section in which automatic steering based on determination by the information processing system is not allowed;
   an input unit that receives, from a passenger of the traveling body, input of the option selected by the passenger's own determination; and
   a control unit that performs steering control of the traveling body on a basis of the option that has been received.

### REFERENCE SIGNS LIST

1 VEHICLE
11 VEHICLE CONTROL SYSTEM
21 VEHICLE CONTROL ELECTRONIC CONTROL UNIT (ECU)
22 COMMUNICATION UNIT
23 MAP INFORMATION ACCUMULATING UNIT
24 POSITION INFORMATION ACQUIRING UNIT
25 EXTERNAL RECOGNITION SENSOR
26 IN-VEHICLE SENSOR
27 VEHICLE SENSOR
28, 230 STORAGE UNIT
29 TRAVEL ASSISTANCE AND AUTONOMOUS DRIVING CONTROL UNIT
30 DRIVER MONITORING SYSTEM (DMS)
31, 900, 910, 920 HUMAN-MACHINE INTERFACE (HMI)
32 VEHICLE CONTROL UNIT
41 COMMUNICATION NETWORK
51 CAMERA
52 RADAR
53 LiDAR
54 ULTRASONIC SENSOR
61 ANALYSIS UNIT
62 ACTION PLANNING UNIT
63 OPERATION CONTROL UNIT
71 SELF-POSITION ESTIMATION UNIT
72 SENSOR FUSION UNIT
73 RECOGNITION UNIT
81 STEERING CONTROL UNIT
82 BRAKE CONTROL UNIT
83 DRIVE CONTROL UNIT
84 BODY SYSTEM CONTROL UNIT
85 LIGHT CONTROL UNIT
86 HORN CONTROL UNIT
101B, 101F, 102B, 102F, 102L, 102R, 103B, 103F, 103L, 103R,
105, 106 SENSING AREA
200 BLOCK
210 PROCESSING UNIT
212 MONITORING UNIT
214 INFORMATION ACQUISITION UNIT
216 INFORMATION PRESENTATION UNIT
218 OPTION PRESENTATION UNIT
220 INPUT UNIT
222 DETERMINATION UNIT
224 CONTROL UNIT
226 EVALUATION UNIT
902 AR DISPLAY
950 STEERING WHEEL

1. An information processing device for performing automatic steering of a traveling body, the information processing device comprising:
an option presentation unit that presents a plurality of options of steering content in a second section
when the traveling body moves from a first section in which automatic steering based on determination by the information processing device is allowed to the second section in which automatic steering based on determination by the information processing device is not allowed;
an input unit that receives, from a passenger of the traveling body, input of the option selected by the passenger's own determination; and
a control unit that performs steering control of the traveling body on a basis of the option that has been received.

2. The information processing device according to claim 1, further comprising:
an information acquisition unit that acquires information for steering; and
an information presentation unit that provides the information to the passenger,
wherein, when the traveling body moves from the first section to the second section,
the information presentation unit presents the information to the passenger.

3. The information processing device according to claim 2, further comprising:
a determination unit that determines steering content on a basis of the information,
wherein, in the first section, the control unit performs steering control of the traveling body on a basis of determination by the determination unit.

4. The information processing device according to claim 2, wherein the information presentation unit presents the information by VR display.

5. The information processing device according to claim 1, wherein the plurality of options includes at least one of an emergency stop, an electronic traction request, a remote steering assistance request, or low-speed autonomous driving.

6. The information processing device according to claim 1, further comprising:
a monitoring unit that monitors a state of the passenger,
wherein the option presentation unit changes content of the options depending on the state of the passenger.

7. The information processing device according to claim 1, wherein the option presentation unit changes content of the options depending on a degree of disability of the passenger.

8. The information processing device according to claim 1, wherein the input unit changes a form of receiving the option that has been selected depending on a degree of disability of the passenger.

9. The information processing device according to claim 8, wherein the input unit selects any one input form from among operation input, voice input, line-of-sight detection input, gesture detection input, and biometric signal change detection input.

10. The information processing device according to claim 9, wherein the operation input is input via a steering wheel, a lever, a pedal, or a touch panel.

11. The information processing device according to claim 1, further comprising an evaluation unit that evaluates a selection result of the passenger depending on a traveling situation of the traveling body in the second section.

12. The information processing device according to claim 11, wherein the evaluation unit reduces points held by the passenger in a case where the traveling body enters a predetermined situation in the second section.

13. The information processing device according to claim 12, wherein the evaluation unit does not allow use of the traveling body in a case where the points held by the passenger is equal to or less than a predetermined number of points.

14. The information processing device according to claim 11, further comprising:
a storage unit that stores the plurality of options and the selection result of the passenger.

15. An information processing system for performing automatic steering of a traveling body, the information processing system comprising:
an option presentation unit that presents a plurality of options of steering content in a second section
when the traveling body moves from a first section in which automatic steering based on determination by the information processing system is allowed to the second section in which automatic steering based on determination by the information processing system is not allowed;
an input unit that receives, from a passenger of the traveling body, input of the option selected by the passenger's own determination; and
a control unit that performs steering control of the traveling body on a basis of the option that has been received.
